(19) United States
(12) Patent Application Publication
(10) Pub. No.: US 2024/0393129 A1
(43) Pub. Date: Nov. 28, 2024

(54) VEHICLE NAVIGATION METHOD AND APPARATUS, DEVICE, STORAGE MEDIUM, AND COMPUTER PROGRAM PRODUCT

(71) Applicant: Tencent Technology (Shenzhen) Company Limited, Shenzhen (CN)

(72) Inventor: Honglong ZHANG, Shenzhen (CN)

(73) Assignee: Tencent Technology (Shenzhen) Company Limited, Shenzhen, GD (CN)

(21) Appl. No.: 18/794,479

(22) Filed: Aug. 5, 2024

Related U.S. Application Data
(63) Continuation of application No. PCT/CN2023/093831, filed on May 12, 2023.

(30) Foreign Application Priority Data
Jun. 30, 2022 (CN) 202210758586.2

(51) Int. Cl. G01C 21/36

(52) U.S. Cl. CPC G01C 21/367

(57) ABSTRACT

A vehicle navigation method, including: displaying a vehicle navigation interface for navigating a physical vehicle, the vehicle navigation interface including a map; displaying a virtual vehicle on a target road on the map, the virtual vehicle corresponding to the physical vehicle; determining, when the physical vehicle travels to a current position and is in a target traveling scenario, road range data corresponding to the target traveling scenario and the current position; and updating a map span and a view angle for displaying the map to a target map span and a target view angle, the target map span and the target view angle being adapted to the road range data.

### RELATED APPLICATION

This application is a continuation of International Application No. PCT/CN2023/093831, filed May 12, 2023, which claims priority to Chinese Patent Application No. 202210758586.2, entitled “VEHICLE NAVIGATION METHOD AND APPARATUS, DEVICE, STORAGE MEDIUM, AND COMPUTER PROGRAM PRODUCT” filed with the China National Intellectual Property Administration on Jun. 30, 2022. The contents of International Application No. PCT/CN2023/093831 and Chinese Patent Application No. 202210758586.2 are each incorporated herein by reference in their entirety.

### FIELD OF THE TECHNOLOGY

This application relates to the field of map navigation technologies, and in particular, to a vehicle navigation method and apparatus, a computer device, a storage medium, and a computer program product.

### BACKGROUND OF THE DISCLOSURE

With the development of computer technologies, map navigation tools, especially vehicle navigation, have been widely used in route navigation and have played a great role in people's daily traveling. During vehicle traveling, a navigation device usually displays a vehicle navigation interface based on traveling speed, a direction, and a vehicle position of a vehicle combined with a navigation route planned for the vehicle, to achieve the vehicle navigation. Usually, on the vehicle navigation interface, a display ratio of a navigation map is fixed, resulting in a poor presentation of road conditions and navigation effect.

### SUMMARY

This application provides a vehicle navigation method. The method includes:

displaying a vehicle navigation interface for navigating a physical vehicle, the vehicle navigation interface including a map;

displaying a virtual vehicle on a target road on the map, the virtual vehicle corresponding to the physical vehicle;

determining, when the physical vehicle travels to a current position and is in a target traveling scenario, road range data corresponding to the target traveling scenario and the current position, and

updating a map span and a view angle for displaying the map to a target map span and a target view angle, the target map span and the target view angle being adapted to the road range data.

This application further provides a vehicle navigation apparatus. The apparatus includes:
an interface display module, configured to display a vehicle navigation interface for navigating a physical vehicle, the vehicle navigation interface including a map; and
a map display module, configured to display a virtual vehicle on a target road on the map, the virtual vehicle corresponding to the physical vehicle, determine, when the physical vehicle travels to a current position and is in a target traveling scenario, road range data corresponding to the target traveling scenario and the current position, and update a map span and a view angle for displaying the map to a target map span and a target view angle, the target map span and the target view angle being adapted to the road range data.

This application further provides a computer device, including a memory and a processor, the memory having computer-readable instructions stored therein, and the processor, when executing the computer-readable instructions, implementing operations of the vehicle navigation method.

This application further provides a computer-readable storage medium, having computer-readable instructions stored thereon, the computer-readable instructions, when executed by a processor, implementing operations of the vehicle navigation method.

This application further provides a computer program product, including computer-readable instructions, the computer-readable instructions, when executed by a processor, implementing operations of the vehicle navigation method.

### BRIEF DESCRIPTION OF THE DRAWINGS

Accompanying drawings herein are incorporated into the specification and constitute a part of this specification, show embodiments that conform to this application, and are used for describing a principle of this application together with this specification. Apparently, the accompanying drawings described below are merely some embodiments of this application, and a person of ordinary skill in the art may further obtain other accompanying drawings according to the accompanying drawings without creative efforts.

FIG. 1 is a diagram of an application environment of a vehicle navigation method according to an embodiment.

FIG. 2 is a schematic diagram of map effects at different scale levels according to an embodiment.

FIG. 3 is a schematic diagram of map ranges viewed from different view angles according to an embodiment.

FIG. 4 is a schematic diagram of map ranges viewed from different view angles according to another embodiment.

FIG. 5 is a schematic diagram of a relationship between a scale and a skew angle according to an embodiment.

FIG. 6 is a schematic diagram of a vehicle navigation system according to an embodiment.

FIG. 7 is a schematic flowchart of data processing of an autonomous driving system according to an embodiment.

FIG. 8 is a schematic diagram of comparison between a rendering effect of a standard definition map and a rendering effect of a high definition map according to an embodiment.

FIG. 9 is a schematic diagram of switching logic of a driving state of an autonomous driving vehicle according to an embodiment.

FIG. 10 is a schematic flowchart of a vehicle navigation method according to an embodiment.

FIG. 11 is a schematic diagram of calculating skew angles at different map spans according to an embodiment.

FIG. 12 is a schematic flowchart of automatically adjusting a graphics effect in an autonomous driving scenario according to an embodiment.

FIG. 13 is a schematic diagram of a straight-forward traveling scenario according to an embodiment.

FIG. 14 is a schematic diagram of a road horizontal observation range in a lane change scenario according to an embodiment.

FIG. 15 is a schematic diagram of a lane change scenario according to an embodiment.

FIG. 16 is a schematic diagram of searching for a second lane in a lane change scenario according to an embodiment.

FIG. 17 is a schematic diagram of calculating an estimated landing position of a physical vehicle according to an embodiment.

FIG. 18 is a schematic diagram of an avoidance scenario according to an embodiment.

FIG. 19 is a schematic diagram of a position of an ego vehicle and positions of obstacles according to an embodiment.

FIG. 20 is a schematic diagram of an autonomous driving control switching scenario according to an embodiment.

FIG. 21 is a diagram of a rendering effect of an autonomous driving control switching scenario according to an embodiment.

FIG. 22 is a schematic diagram of a road observation range in a control switching scenario according to an embodiment.

FIG. 23 is a schematic diagram of a rendering effect of a maneuver position scenario in an autonomous driving scenario according to an embodiment.

FIG. 24 is a block diagram of a structure of a vehicle navigation apparatus according to an embodiment.

FIG. 25 is a diagram of an internal structure of a computer device according to an embodiment.

### DESCRIPTION OF EMBODIMENTS

To make the objectives, technical solutions, and advantages of this application clearer, the following further describes this application in detail with reference to the accompanying drawings and embodiments. The specific embodiments described herein are merely used to explain this application but are not intended to limit this application.

A vehicle navigation technology is a technology that maps a real-time position relationship between a vehicle and a road on a visual vehicle navigation interface based on positioning data provided by a satellite positioning system, to provide a navigation function to an object (such as a driver or a passenger) in the vehicle during vehicle traveling. Based on the visual vehicle navigation interface and a map on the vehicle navigation interface, the object can understand information such as a current position of the vehicle, a traveling route of the vehicle, traveling speed of the vehicle, a road condition in front of the vehicle, lanes of a road, a traveling condition of another vehicle near the position of the vehicle, and a road scenario.

The following describes some concepts involved in the vehicle navigation technology.

Autonomous driving domain is a collection of software and hardware in a vehicle used to control autonomous driving.

Cockpit domain is a collection of hardware and software, including a central control screen, an instrument screen, an operation button, and the like, used in a vehicle to interact with a user in a cockpit, for example, a navigation map displayed on the central control screen and an interface to interact with the user in the cockpit.

HD Map refers to a high definition map.

SD Map refers to a standard definition map.

2.5D view angle refers to a base map tilt mode. In this mode, 3D rendering effects such as 3D building blocks and 4K bridge effect can be displayed.

ACC refers to adaptive cruise control, and is provided by an autonomous driving system to dynamically adjust speed of an ego vehicle based on cruising speed and a safe distance from a vehicle in front set by a user. When the vehicle in front accelerates, the ego vehicle also accelerates to set speed. When the vehicle in front decelerates, the ego vehicle also decelerates to maintain the safe distance between the ego vehicle and the vehicle in front.

LCC refers to lane center control, and is a function provided by autonomous driving to assist a driver in controlling a steering wheel, and can continuously keep a vehicle centered in a current lane.

NOA refers to navigate on autopilot, NOA for short. According to this function, a destination may be set to guide a vehicle to drive automatically, and the vehicle can complete operations such as lane change, overtaking, and automatic entry and exit of ramps under driver's monitoring. Driving activities of NOA include cruising, following, avoiding, yielding, a single-rule planning lane change activity (such as merging into a fast lane and expected exit), and a multi-condition decision-making lane change activity (such as changing lanes during cruising).

Maneuver position is a position on an electronic map that guides a driver to perform maneuvers such as turning, decelerating, merging, and exiting. The maneuver position is usually an intersection turning position, intersection diverging position, intersection merging position, and the like.

Landing position is a predicted position of a physical vehicle when an autonomous driving system completes an autonomous lane change.

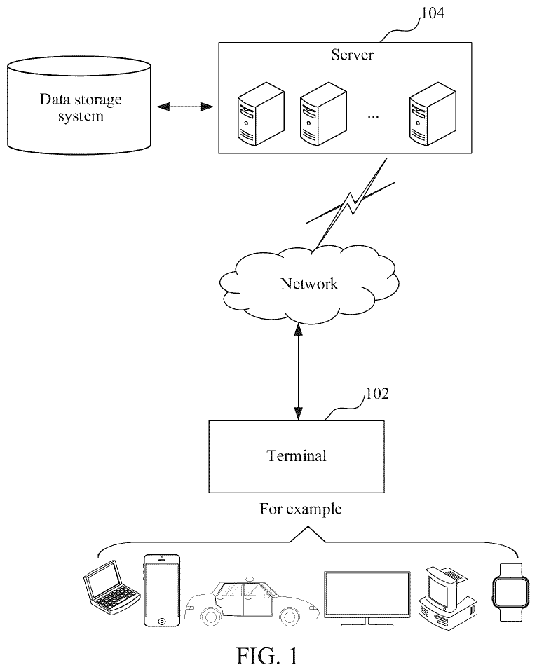

A vehicle navigation method provided in an embodiment of this application may be applied to an application environment shown in FIG. 1. The application environment includes a terminal 102 and a server 104. The terminal 102 communicates with the server 104 over a network. A data storage system may store data, such as map data, including high definition map data, standard definition map data, and the like, that needs to be processed by the server 104. The data storage system may be integrated on the server 104 or placed on cloud or on another server.

The terminal 102 may include but is not limited to a mobile phone, a computer, an intelligent voice interaction device, a smart home appliance, an on-board terminal, and the like. The terminal may alternatively be a portable wearable device, such as a smartwatch or a smart band. The server 104 may be implemented by using an independent server or a server cluster that includes a plurality of servers. The server 104 may be, for example, a server that provides functional services for a map, including a positioning service, a navigation service, and the like. Positioning data about a physical vehicle may be obtained by using the positioning service and the navigation service. The server 104 may receive the positioning data about the physical vehicle, sensing data of an environment in which the physical vehicle is located, and the like, generate a vehicle navigation interface about the physical vehicle based on the data, and display the vehicle navigation interface through the terminal 102. Certainly, the terminal 102 may alternatively receive the positioning data, the sensing data, and the like about the physical vehicle, and generate and display the vehicle navigation interface about the physical vehicle based on the data. Embodiments of this application may be applied to various scenarios, including but not limited to a cloud technology, artificial intelligence, smart transportation, assisted driving, autonomous driving, and the like.

Similar to an actual map, an electronic map in the vehicle navigation interface (hereinafter referred to as a map) also has a display ratio. A map display ratio is also referred to as a scale, which indicates a ratio of a distance on a displayed map to a distance on an actual map. For example, 1 cm on the map in the vehicle navigation interface represents 1 km on the actual map. There is a correspondence between a map span and the display ratio. A smaller display ratio indicates a larger map span, in other words, a larger road range displayed on the map indicates rougher map details. A larger display ratio indicates a smaller map span, in other words, a smaller the road range displayed on the map indicates more detailed and realistic map details.

As shown in the following table, a correspondence is established between a scale level and an actual geographical area size. The circumference of the earth is approximately 40,000 kilometers. In an embodiment, the circumference of the earth is used as the minimum scale level 0. As the level increases, the map span decreases gradually. A specific correspondence is shown in the following Table 1. The correspondence between the scale level and the map span is merely an example. The scale level may alternatively be a decimal, for example, 22.5, and a corresponding map span is 15 meters.

TABLE 1

| Scale level | map span (unit: km) | Scale level | map span (unit: meter) |
|---|---|---|---|
| 0 | 40000 | 13 | 5000 |
| 1 | 20000 | 14 | 2500 |
| 2 | 10000 | 15 | 1250 |
| 3 | 5000 | 16 | 625 |
| 4 | 2500 | 17 | 312 |
| 5 | 1250 | 18 | 156 |
| 6 | 625 | 19 | 78 |
| 7 | 312 | 20 | 39 |
| 8 | 156 | 21 | 20 |
| 9 | 78 | 22 | 10 |
| 10 | 39 | 23 | 5 |
| 11 | 20 | 24 | 2 |
| 12 | 10 | 25 | 1 |

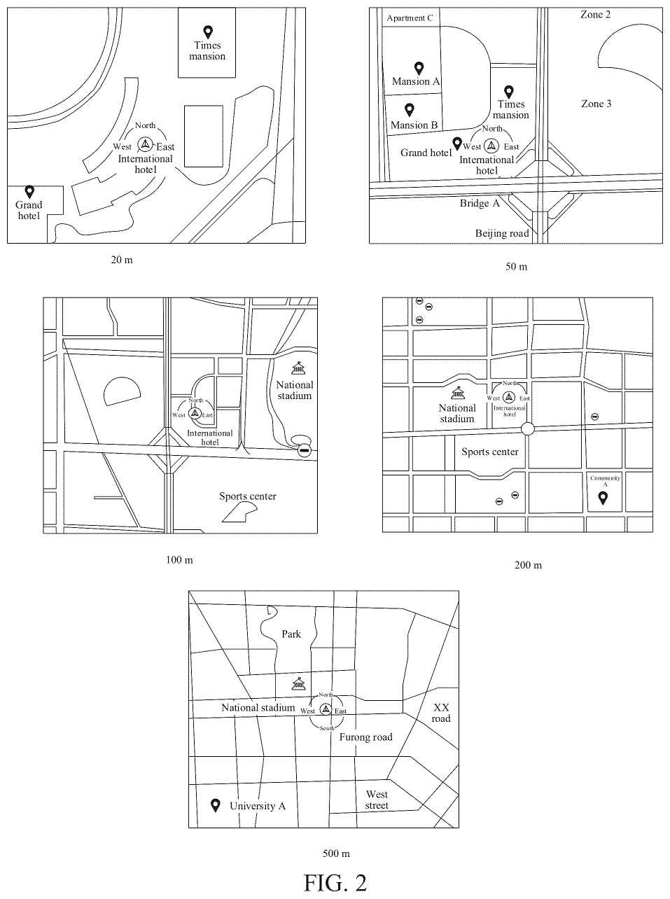

FIG. 2 is a schematic diagram of map effects at different scale levels according to an embodiment. It can be learned from FIG. 2 that, in a map shown in FIG. 2, a map with a map span of 20 meters is displayed larger and a map range is smaller, and a map with a map span of 500 meters is displayed smaller and a map range is larger.

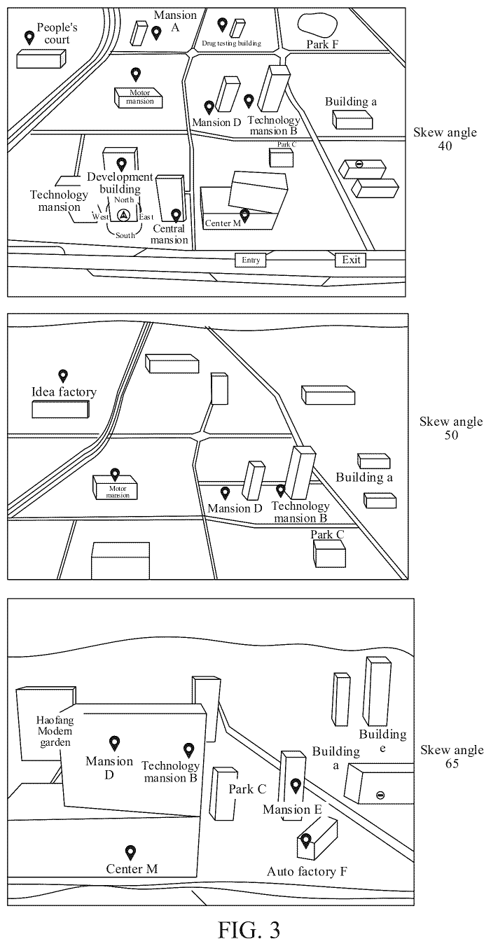

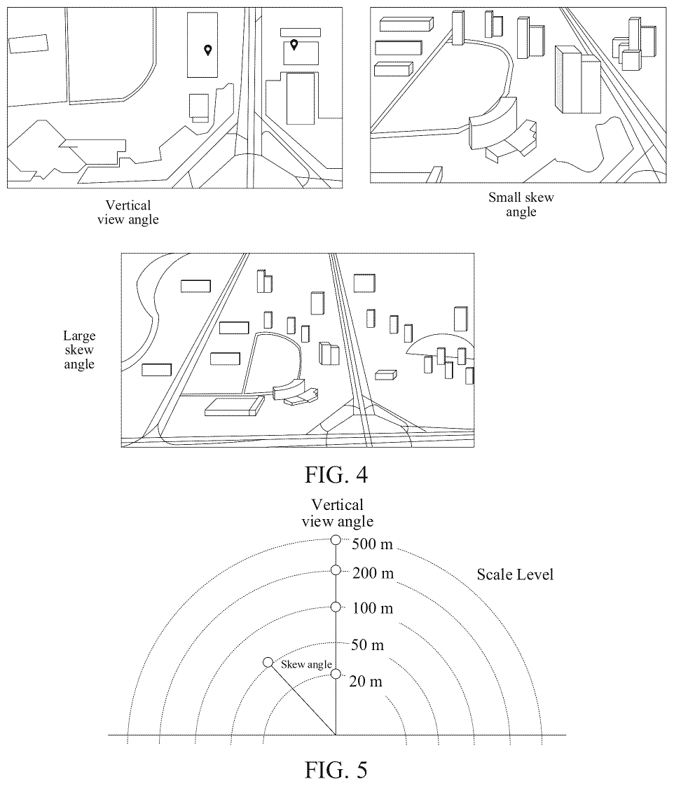

A view angle of the map in the vehicle navigation interface is a view angle for viewing the map, and the view angle may be, for example, a skew angle of the map. FIG. 3 is a schematic diagram of map ranges viewed from different view angles according to an embodiment. Refer to FIG. 3. At the same scale level, skew angles are 40 degrees, 50 degrees, and 65 degrees, respectively. It can be learned that, at the same scale level, a larger skew angle indicates a larger visible range, and a smaller skew angle indicates a smaller visible range. FIG. 4 is a schematic diagram of map ranges viewed from different view angles according to another embodiment. The view angles are a vertical view angle, a small skew angle, and a large skew angle in sequence, map spans and buildings presented from different view angles have different effects.

FIG. 5 is a schematic diagram of a relationship between a scale and a skew angle according to an embodiment. Referring to FIG. 5, at the same view angle (such as a vertical view angle), a visible range of a map span of 20 meters is the smallest, and a visible range of a map span of 500 meters is the largest. At the same scale level (such as 20 meters), a larger skew angle indicates a larger visible range, and a smaller skew angle indicates a smaller visible range. It can be learned that, at the same map span, that is, at the same scale level, the skew angle is adjusted to adjust visible ranges in different directions. The skew angle is adjusted to expand the visible range and even present an over-the-horizon geographic area in a map.

To enable a physical vehicle to use a vehicle navigation function smoothly, in some vehicle navigation manners, a display ratio of the map uses a speed change adapting manner, only considering a speed factor but no road range that the physical vehicle needs to pay attention to in various traveling scenarios. A map range displayed on a map navigation interface is limited, resulting in a poor navigation effect. In addition, during vehicle traveling, a navigation view angle is usually set in advance and fails to perform an adaptive adjustment to a traveling scenario of a current position of the physical vehicle, resulting in poor vehicle navigation efficiency.

In view of this, to provide a good navigation effect and improve navigation efficiency for the physical vehicle, an embodiment of this application provides a vehicle navigation method. According to the method, a road condition of a target road at the current position of the physical vehicle is paid attention to, and a traveling scenario at the current position of the physical vehicle is also paid attention to, which are together used as factors for adjusting a map span and a view angle to achieve an effect of comprehensively adjusting a road range presented on a navigation map interface. The map span and the view angle of a map on the navigation map interface can be adjusted based on a current traveling scenario of the physical vehicle and an actual situation of a road at the current position of the physical vehicle, to improve perceptibility for various traveling scenarios. Road ranges that need to be paid attention to in various traveling scenarios are focused to improve a navigation effect, and to further facilitate understanding of a driver or a passenger in the physical vehicle on a decision of a driving system and improve trustworthiness on the driving system.

Specifically, in an embodiment, the terminal 102 may display a vehicle navigation interface for navigating the physical vehicle, the vehicle navigation interface including a map; display a virtual vehicle on a target road on the map, the virtual vehicle corresponding to the physical vehicle; when the physical vehicle travels to a current position and is in a target traveling scenario, determine road range data corresponding to the target traveling scenario and the current position; and update a map span and a view angle for displaying the map to a target map span and a target view angle, the target map span and the target view angle being adapted to the road range data.

In other words, the target map span and the target view angle required for updating the map are determined based on an actual road condition of the target road at the current position of the physical vehicle and the traveling scenario at the current position of the physical vehicle. When the physical vehicle is in the target traveling scenario, a display manner of the map may be adjusted in real time to enable the display manner to be adapted to a road range that a user needs to observe in the target traveling scenario. In other words, a road range displayed on an updated map is adapted to a road area that needs to be specially observed in a traveling scenario of a position of a vehicle. This can improve perceptibility for a map change, greatly improve quality of navigation map, increase map reading speed, and improve navigation experience. In addition, based on the target view angle of the updated map, a visible range of the map can be expanded when the target map span is small, which may improve navigation efficiency.

The traveling scenario includes at least one preset target traveling scenario, such as a lane change scenario, an avoidance scenario, a control switching scenario, or a maneuver position scenario. The lane change scenario refers to the physical vehicle actively changing a traveling lane during traveling. In the lane change scenario, it is necessary to focus on a lane to be changed to and behind vehicles coming from the lane. The avoidance scenario is a scenario in which the physical vehicle needs to decelerate, change a lane, or the like to avoid a dangerous situation when encountering an obstacle during traveling, such as a vehicle overtaking, a vehicle in front decelerating, or a vehicle in front changing a lane, resulting in a poor road condition in a current lane. In the avoidance scenario, it is necessary to focus on the obstacle and a lane where the obstacle is located. The control switching scenario is a scenario in which an autonomous driving vehicle is about to leave an area in which an autonomous driving function is supported and is about to be switched to manual driving. In the autonomous driving control switching scenario, it is necessary to focus on a position on a road where an autonomous driving is exited. The maneuver position scenario refers to a location where the physical vehicle performs maneuvers such as turning or turning around during traveling. In the maneuver position scenario, it is necessary to focus on a road condition of a maneuver position ahead.

In addition to the foregoing traveling scenarios, the target traveling scenario may further include another scenario, which is not limited in this application. Road ranges that need to be focused on may be different in different traveling scenarios. Also, in addition to a plurality of foregoing target traveling scenarios, the traveling scenario may further include a straight-forward traveling scenario. The straight-forward traveling scenario is a scenario in which a vehicle travels straight ahead without changing a lane, turning around, steering, or the like. In the straight-forward traveling scenario, a map span and a view angle of a presented map may be preset values without changing with a target road of a current position of the vehicle. A terminal can represent the traveling scenario of the physical vehicle through different identifiers. In other words, different identifiers represent different types of traveling scenarios.

The vehicle navigation method provided in this embodiment of this application may be applied to a vehicle navigation process in an autonomous driving scenario. The autonomous driving scenario is a vehicle driving scenario, and is a scenario in which the vehicle is controlled by an on-board autonomous driving system to travel. During the vehicle navigation process in the autonomous driving scenario, a visual vehicle navigation interface is presented to a driver or a passenger in the vehicle to enable the driver or the passenger to clearly and intuitively understand a road environment in which the vehicle is located. According to this embodiment of this application, the road environment of the target road at the current position of the autonomous driving vehicle and the traveling scenario at the current position of the autonomous driving vehicle are combined to comprehensively determine the map span and the view angle required for updating the map on the vehicle navigation interface, so as to present a change of the map. This can improve perceptibility for a scenario in which the vehicle is located in the autonomous driving scenario, and improve trustworthiness of a member in the vehicle on the autonomous driving system and a sense of driving safety provided by the autonomous driving system for the member.

The vehicle navigation system provided in this embodiment of this application may also be applied to a vehicle navigation process in an active driving system. An active driving scenario is a human driving scenario, and is a scenario in which the vehicle is controlled by a driver. During the vehicle navigation process in the active driving scenario, a visual vehicle navigation interface is presented to the driver in the vehicle to enable the driver to clearly and intuitively understand the vehicle, a road environment in which the vehicle is located, and a traveling state of the vehicle. According to this embodiment of this application, a navigation environment of a target road where the vehicle is currently located and a traveling scenario where the vehicle is currently located are combined to jointly adjust the map span and the view angle of the map on the vehicle navigation interface, so as to present a change of the map. This can improve perceptibility for a scenario in which the vehicle is located. The driver can make a driving decision based on the presented vehicle navigation interface, thereby improving traffic safety during vehicle traveling.

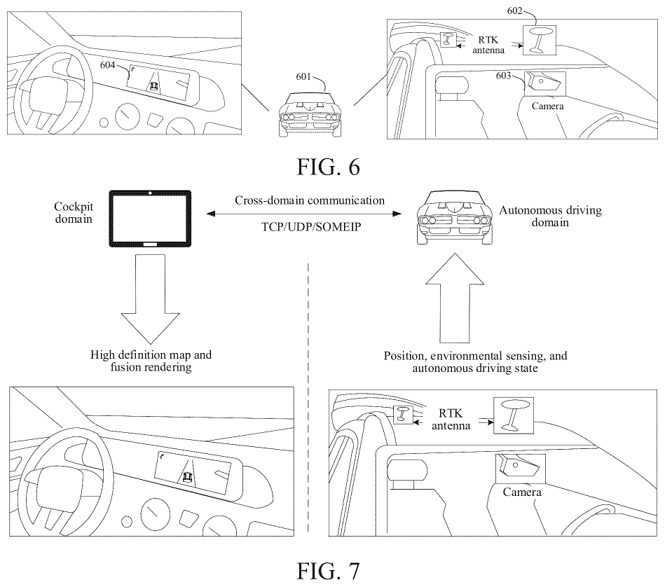

The vehicle navigation method provided in this embodiment of this application may also be applied to a vehicle navigation system as shown in FIG. 6. The vehicle navigation system includes a physical vehicle 601, a positioning device 602, a sensing device 603, and an on-board terminal 604. The positioning device 602, the sensing device 603, and the on-board terminal 604 are mounted in the vehicle 601.

The positioning device 602 may be configured to obtain position data (that is, position data of the physical vehicle 601) of the physical vehicle 601 (that is, an ego vehicle) in a world coordinate system. The world coordinate system is an absolute coordinate system of the system. For example, the positioning device can obtain the position data of the physical vehicle 601 based on a GPS technology. The positioning device 601 can send the position data of the physical vehicle 601 in the world coordinate system to the on-board terminal 604, and the on-board terminal 604 can obtain a current position of the physical vehicle in real time. The positioning device mentioned in this embodiment of this application may be a real time kinematic (RTK) positioning device. The RTK positioning device can provide high-precision (for example, centimeter-level) positioning data (that is, the position data of the physical vehicle 601) of the vehicle 601 in real time.

The sensing device 603 may be configured to sense an environment where the physical vehicle 601 is located to obtain environmental sensing data. A sensed object may be another vehicle or an obstacle on a target road. For example, the environmental sensing data may include position data (to be specific, coordinate data of another vehicle relative to the physical vehicle 601) of another vehicle (such as an overtaking vehicle or a vehicle in front in an avoidance scenario or an oncoming vehicle in a lane change scenario) on the target road where the physical vehicle 601 is located in a vehicle coordinate system of the physical vehicle 601. The environmental sensing data further includes data that the physical vehicle 601 needs to know in different scenarios, for example, a predicted landing position on a lane in the lane change scenario and an autonomous driving exit position on a lane in a control switching scenario. The vehicle coordinate system is a coordinate system established with a vehicle center of the physical vehicle 601 as a coordinate origin. The sensing device 603 may send the environmental sensing data to the on-board terminal 604. The sensing device 603 includes a visual sensing device and a radar sensing device. A sensing range of the environment where the physical vehicle 601 is located sensed by the sensing device 603 is determined by a sensor integrated in the sensing device. Generally, the sensing device may include but is not limited to at least one of the following sensors: a visual sensor (such as a camera), a long-range radar, or a short-range radar. A detection distance supported by the long-range radar is longer than a detection distance supported by the short-range radar.

The on-board terminal 604 integrates a satellite positioning technology, a mileage positioning technology, and an automobile black box technology, and is a terminal device for driving safety management, operation management, service quality management, intelligent centralized dispatching management, electronic station board control management, and the like. The on-board terminal 604 may include a display screen, such as a central control screen, an instrument screen, an augmented reality head up display (ARHUD) display screen, and the like. After receiving the position data and the environmental sensing data of the physical vehicle 601, the on-board terminal 604 may convert position data of the sensed object in the vehicle coordinate system into position data of the sensed object in the world coordinate system. In other words, relative position data of the sensed object is converted into the position data of the sensed object. Then, the on-board terminal 604 may display, based on the position data of the sensed object, a mark representing the sensed object in a navigation interface displayed on the display screen.

Using the autonomous driving scenario as an example, the vehicle navigation method provided in this embodiment of this application involves a cross-domain communication between an autonomous driving domain and a cockpit domain. The autonomous driving domain refers to a collection of software and hardware in a vehicle used to control autonomous driving. For example, the positioning device 602 and the sensing device 603 mentioned above both belong to the autonomous driving domain. The cockpit domain refers to a collection of hardware and software in the physical vehicle, including a central control screen, an instrument screen, an operation button, and the like, used to control interaction with a vehicle-related object in a cockpit. For example, the on-board terminal 604 mentioned above belongs to the cockpit domain. The cockpit domain and the autonomous driving domain are two relatively independent processing systems. The two systems transmit data across domains based on an on-board Ethernet through data transmission protocols such as transmission control protocol (TCP), user datagram protocol (UDP), and scalable service-oriented middleware over IP (SOME/IP, which is a data transmission protocol). The on-board Ethernet can achieve a high data transmission rate (for example, 1000 Mbit/s), and also satisfies requirements of an automotive industry in terms of high reliability, low electromagnetic radiation, low power consumption, low latency, and the like.

FIG. 7 is a schematic flowchart of data processing of an autonomous driving system according to an embodiment. Referring to FIG. 7, after collecting the positioning data and the environmental sensing data, the autonomous driving domain packages the data and transmits the packaged data to the cockpit domain in a the cross-domain communication method. After receiving the packaged data, the cockpit domain performs a correction operation on the positioning data in the packaged data with reference to high definition map information to obtain a corrected positioning position of the physical vehicle, then integrates, based on the positioning position, another sensed object sensed by the sensing data into a high definition map, and finally presents all integrated information in the form of the high definition map on the display screen (a display device such as a central control screen, an instrument screen, or an AR-HUD) of the cockpit domain.

A map on a vehicle navigation interface displayed on the display screen may be a standard definition map or the high definition map. Map data has developed from early standard definition data to today's high definition data, and precision of the map data has increased from original 5 to 10 meters to current approximately 50 cm. A graphics effect of a navigation base map has also evolved from original road-level (or path-level) rendering to current lane-level rendering. The graphics effect has expanded from an early flat view angle to a current 2.5D view angle, greatly expanding a field of view at the same display ratio and displaying more over-the-horizon information.

The standard definition map is usually configured to assist a driver in vehicle navigation, and coordinate precision of the standard definition map is approximately 10 meters. In the field of autonomous driving, an autonomous driving vehicle needs to precisely know a position of the physical vehicle. A distance between the physical vehicle and a curb and a distance between the physical vehicle and an adjacent lane each are usually only a few dozen centimeters. Therefore, precision of the high definition map is required to be within 1 meter, and lateral relative precision (such as relative position precision between lanes or relative position precision between a lane and a lane line) is often even higher. In addition, in some cases, the high definition map can further present an accurate shape of a road and include data on a slope, a curvature, a heading, an elevation, and a roll of each lane; a type and a color of a lane line; a speed limit requirement and recommended speed of each lane; a width and a material of an isolation belt; an arrow on a road, content of text, and a location; geographic coordinates, physical dimensions, characteristics, and the like of traffic participants such as traffic lights and crosswalks.

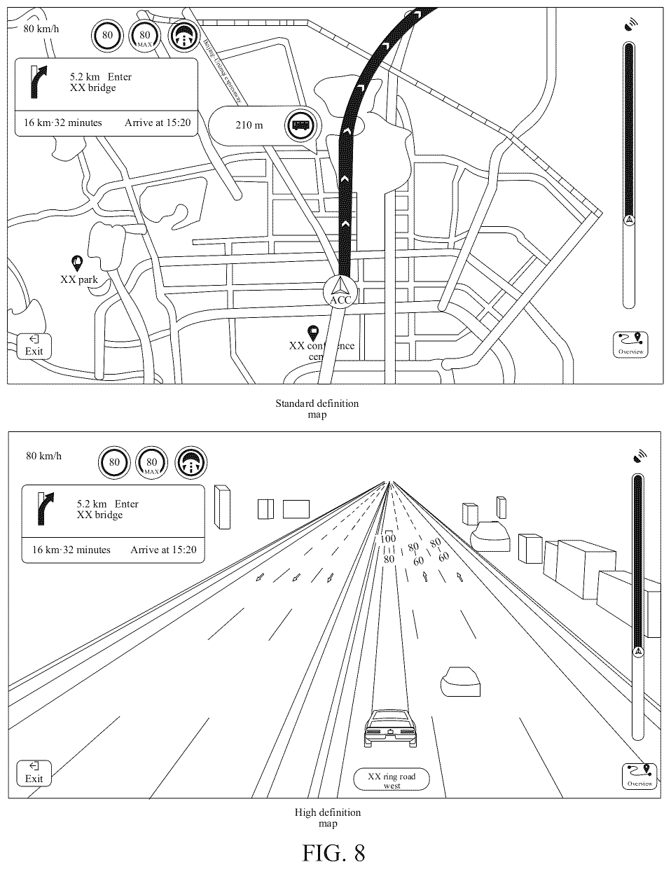

FIG. 8 is a schematic diagram of comparison between a rendering effect of a standard definition map and a rendering effect of a high definition map according to an embodiment. Referring to FIG. 8, the graphics effect undergoes tremendous changes after upgrading from the standard definition map to the high definition map, including: a change in a scale size (map span range), switching of a vertical view angle to a 2.5D view angle, and refinement of a guidance effect (upgrading from path-level to lane-level). These changes need to be adjusted based on an actual application scenario to maximize a value of high definition map rendering.

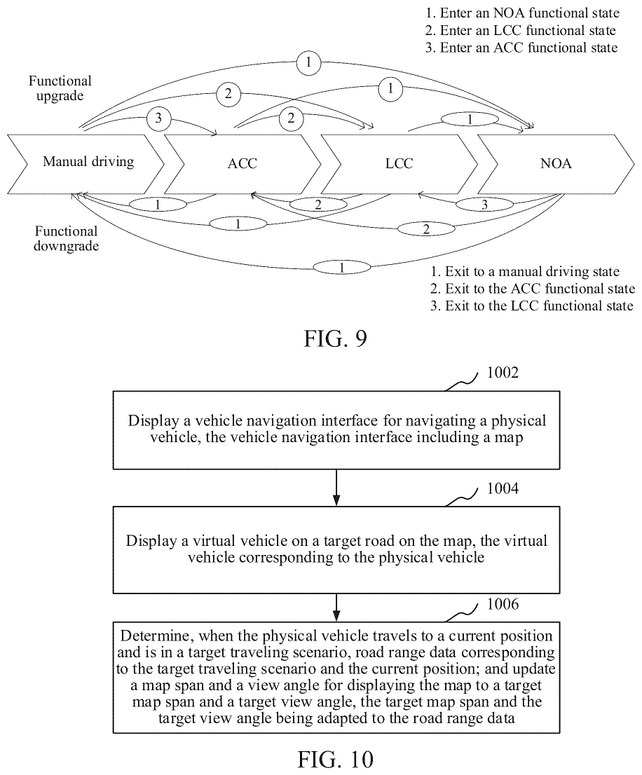

FIG. 9 is a schematic diagram of switching logic of a driving state of an autonomous driving vehicle according to an embodiment. Refer to FIG. 9. An autonomous driving system includes switching between a plurality of driving states (functional states). A functional upgrade refers to a gradual upgrade from a fully manual driving state to a high-level autonomous driving state. The manual driving state may directly upgrade to an ACC state, an LCC state, and an NOA state, or may change to ACC state on, then LCC state on, and finally to the NOA state, step by step. A functional downgrade is the opposite of the functional upgrade, and refers to a process of gradually downgrading from high-level autonomous driving to fully manual driving. The traveling scenario mentioned in embodiments of this application, in the autonomous driving scenario, may be specifically an autonomous lane change scenario, an automatic avoidance scenario, a prompt control switching scenario, an autonomous following scenario, or the like performed by the autonomous driving system in the NOA state.

In an embodiment, as shown in FIG. 10, a vehicle navigation method is provided. An example in which the method is applied to the terminal 102 in FIG. 1 or the on-board terminal 604 in FIG. 6 is used for description, and the method includes the following operation 1002 to operation 1006.

Operation 1002: Display a vehicle navigation interface for navigating a physical vehicle, the vehicle navigation interface including a map.

During physical vehicle traveling, the terminal may display the vehicle navigation interface. The vehicle navigation interface is an interface for navigating the physical vehicle during physical vehicle traveling. The vehicle navigation interface may include the map. The map describes an actual road environment at an actual geographical location of the physical vehicle, including a road, a lane, and an indicator marker in the lane of a target lane where the physical vehicle is located. The map may be a standard definition map or may be a high definition map. For example, in an autonomous driving scenario, the map is the high definition map, and is a virtual road environment obtained by three-dimensional modeling on a road environment. In an ordinary vehicle navigation scenario, the map is the standard definition map, and is a virtual road environment obtained by two-dimensional modeling on the road environment, and may only include road data but not spatial height data.

Operation 1004: Display a virtual vehicle on a target road on the map, the virtual vehicle corresponding to the physical vehicle.

During physical vehicle traveling, the vehicle navigation interface displayed by the terminal also includes the virtual vehicle displayed on the target road. The target road and the virtual vehicle here are both virtual mappings of an actual target road where the physical vehicle is located and the physical vehicle. The virtual vehicle is displayed on the target road of a virtual map on the navigation interface based on current position data of the physical vehicle. A position of the virtual vehicle on the virtual map corresponds to a current position obtained by positioning the physical vehicle. The physical vehicle may be any vehicle that performs vehicle navigation through a displayed map. The target road may include at least one lane, and the target road may be a multi-lane road.

The physical vehicle traveling on the road may be in different traveling scenarios. In other words, there may be a corresponding traveling scenario. The traveling scenario is a scenario of a series of traveling activities performed by a vehicle to achieve safe driving during traveling. The traveling scenario includes at least one target traveling scenario, such as a lane change scenario, an avoidance scenario, a control switching scenario, or a maneuver position scenario. For detailed descriptions of these target traveling scenarios, refer to the foregoing related descriptions. In addition to the foregoing traveling scenarios, the target traveling scenario may further include another scenario, which is not limited in this application. Road ranges that need to be focused on may be different in different traveling scenarios. Also, in addition to a plurality of foregoing target traveling scenarios, the traveling scenario may further include a straight-forward traveling scenario. The straight-forward traveling scenario is a scenario in which a vehicle travels straight ahead without changing a lane, turning around, steering, or the like. In the straight-forward traveling scenario, a map span and a view angle of a presented map may be preset values without changing with the target road at the current position of the physical vehicle. In the autonomous driving scenario, the target traveling scenario may include an autonomous lane change scenario, an automatic avoidance scenario, a prompt control switching scenario, an autonomous following scenario, or the like performed by an autonomous driving system in an NOA state.

The terminal may determine in some manners whether the physical vehicle is in a specific target traveling scenario at the current position. For example, in the ordinary vehicle navigation scenario, the terminal may determine a traveling scenario of a vehicle based on a change in position data of the vehicle. For example, it is determined, based on position data of the physical vehicle and road data at the current position, whether the physical vehicle changes a lane, in other words, whether the physical vehicle is in the lane change scenario. For another example, it is determined, based on the position data of the physical vehicle and the road data at the current position, whether the physical vehicle travels straight within a period of time. If the physical vehicle travels straight within a period of time, the physical vehicle is in the straight-forward traveling scenario. For another example, it is determined, based on the position data of the physical vehicle and the road data at the current position, whether the physical vehicle travels to a control switching position, in other words, whether the physical vehicle is in the prompt control switching scenario, and the like. In other words, in the ordinary vehicle navigation scenario, the traveling scenario may be comprehensively determined based on the position data of the physical vehicle and road data obtained based on an electronic map. For example, in the autonomous driving scenario, a traveling activity of the physical vehicle is decided by an autonomous driving domain. A terminal in a cockpit domain can obtain current traveling activity information (or referred to as a traveling instruction) of the physical vehicle from the autonomous driving domain through cross-domain communication, to obtain a current traveling scenario of the physical vehicle. For example, when the autonomous driving domain issues a “lane change instruction”, the terminal in the cockpit domain can receive the instruction and determine that the physical vehicle is currently in a “lane change scenario”. When the autonomous driving domain issues an “emergency avoidance instruction”, the terminal in the cockpit domain can receive the instruction and determine that the physical vehicle is currently in an “avoidance scenario”, and the like. After obtaining the current traveling scenario of the physical vehicle, the terminal can obtain data, such as vehicle steering information in the lane change scenario, position information of an obstacle relative to the vehicle in the avoidance scenario, or position information of an autonomous driving exit position in the control switching scenario, required for updating the map in the traveling scenario from the autonomous driving domain.

Operation 1006: Determine, when the physical vehicle travels to the current position and is in the target traveling scenario, road range data corresponding to the target traveling scenario and the current position; and update a map span and a view angle for displaying the map to a target map span and a target view angle, the target map span and the target view angle being adapted to the road range data.

The current position is a positioning position of the physical vehicle. A vehicle position of the virtual vehicle displayed on the map is displayed based on the positioning position of the physical vehicle. During physical vehicle traveling, as time goes by, the current position of the physical vehicle changes all the time. For example, a refresh frequency at the current position may be 10 times per second. The target traveling scenario is a traveling scenario at the current position of the physical vehicle. The target traveling scenario may be any one of the foregoing lane change scenario, avoidance scenario, control switching scenario, maneuver position scenario, or another traveling scenario.

Specifically, during physical vehicle traveling, the terminal obtains the current position of the physical vehicle in real time, and determines whether the physical vehicle is in one of the foregoing target traveling scenarios in the manner mentioned above. If the physical vehicle is in one of the foregoing target traveling scenarios, the terminal determines the road range data corresponding to the target traveling scenario and the current position based on the current position and a current specific target traveling scenario, and updates, based on the road range data, the map span and the view angle required for displaying the map to the target map span and the target view angle. The map is updated based on the map span and the view angle determined based on the road range data, so that a road range on an updated map is adapted to a road range that a user needs to pay attention to at the current position when the physical vehicle is in the target traveling scenario. In other words, the road range data is data required for updating the road range displayed on the map, including road horizontal range data and road vertical range data.

For detailed descriptions of the map span and the view angle, refer to the foregoing related descriptions. Based on the foregoing descriptions, map ranges of maps displayed based on different map spans and view angles are different. Certainly, displayed road ranges are also different. For example, a smaller map span indicates a smaller skew angle, a wider displayed road or lane, and a smaller field of view ahead. A larger map span indicates a larger skew angle, a narrower displayed road or lane, and a bigger field of view ahead. In an embodiment of this application, the road range displayed on the updated map is related to a road attribute of the target road where the lane is located, the current position of the physical vehicle on the target road, and the current traveling scenario where the physical vehicle is located. In other words, these factors jointly determine the target map span and the target view angle for updating the map.

The road range data corresponding to the target traveling scenario and the current position is determined in advance based on a road range that needs to be paid attention to during a traveling activity of the physical vehicle in the target traveling scenario. In other words, different target traveling scenarios correspond to different road ranges that need to be paid attention to. For example, in the lane change scenario, it is necessary to observe a lane to be changed to and behind vehicles coming from the lane. Therefore, a road range that needs to be paid attention to in the lane change scenario is mainly a range near the current position of the physical vehicle. For another example, in the avoidance scenario, it is necessary to observe an obstacle and a lane where the obstacle is located. Therefore, a road range that needs to be paid attention to in the avoidance scenario is mainly a range formed by the current position and a position of the obstacle.

In this embodiment, the “adapted to” refers to that the target map span and the target view angle of the updated map are determined based on an actual road condition of the target road at the current position of the physical vehicle and the traveling scenario at the current position of the physical vehicle, so that the road range displayed on the updated map can be adapted to the road range that needs to be paid attention to in the traveling scenario of the position of the physical vehicle. This can improve perceptibility for a map change, greatly improve quality of navigation map, increase map reading speed, and improve navigation experience. In addition, based on the target view angle of the map, a visible range of the map can be expanded when the target map span is small, which may improve navigation efficiency.

In an embodiment, the determining, when the physical vehicle travels to the current position and is in the target traveling scenario, road range data corresponding to the target traveling scenario and the current position includes: determining road horizontal range data and road vertical range data of the target traveling scenario and the current position when the physical vehicle travels to the current position and is in the target traveling scenario.

In an embodiment, the updating a map span and a view angle for displaying the map to a target map span and a target view angle, the target map span and the target view angle being adapted to the road range data includes: determining, based on the road horizontal range data at the current position when the physical vehicle is in the target traveling scenario and the road vertical range data at the current position when the physical vehicle is in the target traveling scenario, the target map span and the target view angle required for updating the map; and displaying the map as a map including the target map span and the target view angle.

The road horizontal range data at the current position when the physical vehicle is in the target traveling scenario is configured for determining the target map span required for updating the map. A wider road horizontal range that needs to be displayed indicates a larger required target map span. The road horizontal range and a road vertical range at the current position when the physical vehicle is in the target traveling scenario are together configured for determining the target view angle required for updating the map. In a case that the road horizontal range is determined, a longer road vertical range that needs to be displayed indicates a larger required target view angle. In actual application, the road horizontal range can reflect traffic conditions on both sides of the vehicle, and the road vertical range can reflect traffic conditions in front and behind the physical vehicle.

The road horizontal range may be quantified by a road horizontal distance that the user observes at the current position when the physical vehicle is in the target traveling scenario. The road horizontal distance may be a road horizontal width of the entire target road, may be a lane horizontal width of the lane where the physical vehicle is located, or may be a lane horizontal width formed by the lane where the physical vehicle is located, an adjacent lane or a neighboring lane of the lane where the physical vehicle is located, which is specifically depending on the target traveling scenario where the physical vehicle is located. The road vertical range may be quantified by a road vertical distance that the user observes at the current position when the physical vehicle is in the target traveling scenario. The road vertical distance may be a maximum distance from the vehicle to an obstacle in front, may be a distance from the physical vehicle to an estimated landing position, or may be a distance from the physical vehicle to the autonomous driving exit position, which is specifically depending on the target traveling scenario where the physical vehicle is located. There are differences between road horizontal distances defined by different target traveling scenarios and between road vertical distances defined by different target traveling scenarios. In other words, road ranges at the same position of the physical vehicle may be different when the physical vehicle is in different traveling scenarios, and road ranges at different positions of the physical vehicle may also be different when the physical vehicle is in the same traveling scenario.

Specifically, when determining that the physical vehicle is in a specific target traveling scenario at the current position, the terminal determines the road horizontal range data at the current position when the physical vehicle is in the target traveling scenario and the road vertical range data at the current position when the physical vehicle is in the target traveling scenario, so that the terminal determines, based on the road horizontal range data and the road vertical range data, the target map span and the target view angle for updating the map. Subsequently, the terminal obtains map data at the current position, and renders and displays the map data based on the target map span and the target view angle to obtain a map to be displayed at the current position when the physical vehicle is in the target traveling scenario.

In an embodiment, the determining, based on the road horizontal range data at the current position when the physical vehicle is in the target traveling scenario and the road vertical range data at the current position when the physical vehicle is in the target traveling scenario, the target map span and the target view angle required for updating the map includes: determining, based on the road horizontal range data at the current position when the physical vehicle is in the target traveling scenario, a map span required for updating the map; determining, based on the required map span and the road vertical range data at the current position when the physical vehicle is in the target traveling scenario, a skew angle required for updating the map; and increasing the required map span when the skew angle is greater than or equal to a preset threshold, and continuing to perform the operation of determining, based on the required map span and the road vertical range data at the current position when the physical vehicle is in the target traveling scenario, a skew angle required for updating the map, until the skew angle is less than the preset threshold, to obtain the target map span and the target view angle required for updating the map.

Specifically, the terminal may determine, based on a road attribute of the target road where the physical vehicle is located, the current position of the physical vehicle, and the target traveling scenario where the physical vehicle is located, the road horizontal distance at the current position when the physical vehicle is in the target traveling scenario, and query, based on the road horizontal distance, a mapping table shown as Table 1 to determine the map span required for updating the map. Subsequently, the terminal determines, based on the road attribute of the target road where the physical vehicle is located, the current position of the physical vehicle, and the target traveling scenario where the physical vehicle is located, the road vertical distance at the current position when the physical vehicle is in the target traveling scenario, and calculates the skew angle based on the required map span determined previously and the road vertical distance. When the skew angle is less than the preset threshold, the terminal uses the required map span determined previously and the skew angle as the target map span and the target view angle required for updating the map. When the skew angle is greater than or equal to the preset threshold, the terminal increases the map span by one level based on a map span list shown in Table 1, recalculates the skew angle based on an increased map span and the road vertical distance, and performs iteration until the skew angle is less than the preset threshold. The preset threshold of the skew angle may be set based on an actual application requirement.

To be specific, a strategy for determining the target map span and the target view angle is:
1. determining, based on the road horizontal range data at the current position when the physical vehicle is in the target traveling scenario, the map span required for updating the map;
2. determining the skew angle based on the road vertical range data at the current position when the physical vehicle is in the target traveling scenario; and
3. adjusting to increase the map span by one level (where the map is zoomed out and a map range is expanded) when the skew angle is greater than or equal to the preset threshold, then recalculating the skew angle based on operations 2 and 3 until the skew angle is less than the preset threshold.

For example, in actual application, regardless of the traveling scenario, for the road horizontal range, information of at least 5 meters in a width direction of a road surface may need to be paid attention to. Based on Table 1, it may be determined that a minimum map span required for displaying the map is approximately 10 meters and a corresponding scale level is 22 when the road horizontal range is approximately 10 meters. In a case that the map span is 10 meters, when the skew angle exceeds 75°, the view angle is almost parallel to the road surface, and there are 3D buildings displayed on the map. In this case, a map rendering effect is not conducive to user viewing, so that a maximum value of the skew angle is 75°. Therefore, the preset threshold may be set to 75°. Certainly, the preset threshold may alternatively be 60°, 40°, or even 20°, which can be set based on an actual application situation and is not limited.

It is assumed that the road horizontal distance is horizontalDist and the road vertical distance is verticalDist. A map span closest to horizontalDist is queried in Table 1. To be specific:

scale=Find{Min{Scale(i)-horizontalDist}},0<i<23.

To be specific, starting from the scale level i=1, Scale (i)-horizontalDist is calculated in sequence, i with a smallest calculation result is used as an initial scale level.

The skew angle is calculated based on an initial map span corresponding to the initial scale level i. A calculation formula for the skew angle is:

skewAngle=arctan(verticalDist/scale).

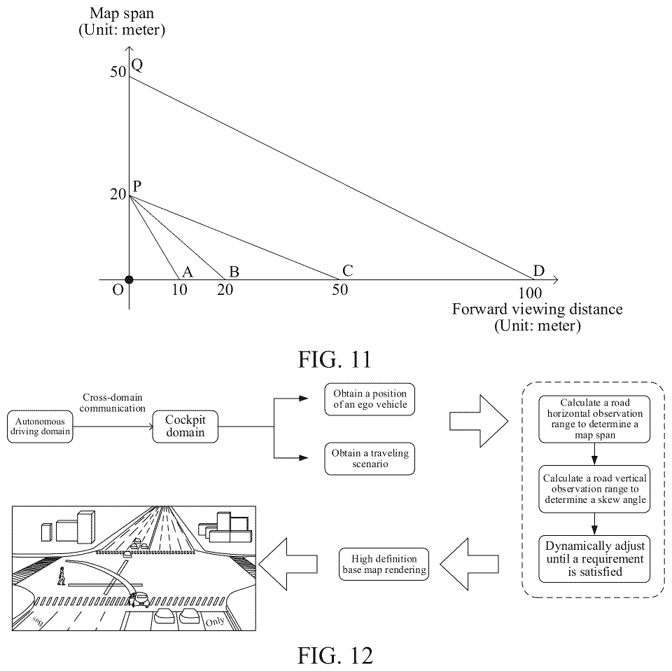

FIG. 11 is a schematic diagram of calculating skew angles at different map spans. For example, a current map span is set to 20 meters based on horizontalDist, and verticalDist is 100 meters, so that skewAngle=arctan (100/20)=78.69°. However, the current skew angle exceeds the preset threshold, so that the map span needs to be increased by one level (where the map span is adjusted to 50 meters). The skew angle is recalculated, so that skewAngle=arctan (100/50)=63.435°, which satisfies the requirement. In this way, the terminal can render and display the obtained map data at the current position based on the map span of 50 meters and the skew angle of 63.435°, so as to present the updated map at the current position when the physical vehicle is in the target traveling scenario.

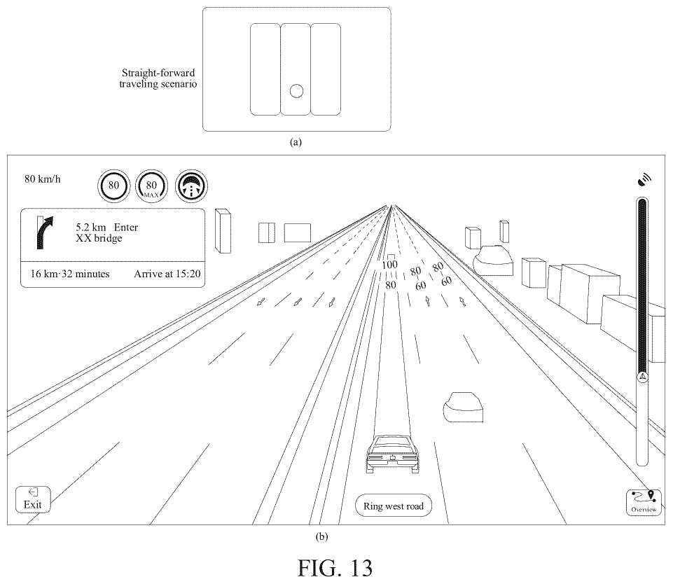

FIG. 12 is a schematic flowchart of automatically adjusting a graphics effect in an autonomous driving scenario. Refer to FIG. 12. A cockpit domain obtains a current position of an ego vehicle and a current target traveling scenario where the physical vehicle is located from an autonomous driving domain through cross-domain communication, calculates road horizontal range data of the current target traveling scenario to determine a map span, calculates road vertical range data of the current scenario to determine a skew angle, dynamically adjusts the map span and the skew angle until the skew angle satisfies a visual requirement, and finally applies an adjusted map span and skew angle to high definition map rendering. Usually, the ego vehicle or a lane where the ego vehicle is located is displayed in the center of a vehicle navigation interface and remains fixed. However, in some target traveling scenarios, other lanes or other vehicles need to be displayed in the center of the vehicle navigation interface. In this case, parameters for rendering a high definition map may further include an offset (or referred to as a center point, to be specific, a location of the center point of the vehicle navigation interface on the map) of the map.

The following uses the autonomous driving scenario and the high definition map as examples to describe some specific traveling scenarios. The traveling scenarios include a straight-forward traveling scenario and a plurality of target traveling scenarios. The target traveling scenarios include a lane change scenario, an avoidance scenario, a control switching scenario, a maneuver position scenario, and the like.

In an embodiment, the target road includes a plurality of lanes, the virtual vehicle is displayed in a first lane among the plurality of lanes, and the method further includes: updating, when the physical vehicle is in a straight-forward traveling scenario at the current position to which the physical vehicle travels, the map span and the view angle for displaying the map to a set map span and a set view angle in the straight-forward traveling scenario; and displaying, in the center of a map in the straight-forward traveling scenario, the first lane in which the virtual vehicle is displayed.

The straight-forward traveling scenario is a scenario in which a vehicle travels straight ahead without changing a lane, turning around, steering, or the like. In the straight-forward traveling scenario, a map span and a view angle of a presented map are preset values without changing with the target road at the current position of the physical vehicle. The terminal may determine the traveling scenario of the physical vehicle based on traveling characteristics of the straight-forward traveling scenario, the current position of the physical vehicle, and the road data, and analyze whether the traveling scenario is the straight-forward traveling scenario. As shown in FIG. 13, section (a) of FIG. 13 is a schematic diagram of a straight-forward traveling scenario. The outer frame represents an entire vehicle navigation interface, the three rectangular frames represent three lanes, and the circle represents a position of an ego vehicle. Section (b) of FIG. 13 is a diagram of a rendering effect of the straight-forward traveling scenario. In an embodiment, in the straight-forward traveling scenario, lanes are displayed in the center of the vehicle navigation interface, and the lane where the physical vehicle is located is also displayed in the center of the vehicle navigation interface. In one embodiment, the ego vehicle is displayed in an area below a lane range of the lane where the vehicle is located. For example, the ego vehicle is displayed at the lower ⅔ of the lane range of the lane where the vehicle is located. In this way, a larger range of a road ahead is presented in the entire map.

In an embodiment, the determining, when the physical vehicle travels to the current position and is in the target traveling scenario, road range data corresponding to the target traveling scenario and the current position includes: calculating, based on road data at the current position, when the physical vehicle travels to the current position and is in a lane change scenario, a road horizontal distance required for the lane change scenario, and calculating, based on the road data at the current position, a maximum vertical extension lane change distance required for lane change from the current position.

Additionally, the lane change scenario refers to the physical vehicle actively changing a traveling lane during traveling. In the lane change scenario, a lane to be changed to and behind vehicles coming from the lane needs to be focused. Road horizontal range data in the lane change scenario may be a road horizontal distance at the current position when the physical vehicle is in the lane change scenario. The road horizontal distance may be a road width of the target road. In a scenario where the target road includes a plurality of lanes, the road horizontal distance may be a horizontal width of lanes formed by the lane where the physical vehicle is located and first left and right lanes adjacent to the lane. The road horizontal distance may alternatively be a horizontal width of lanes formed by the lane where the physical vehicle is located, the first left and right lanes adjacent to the lane, a second left lane adjacent to the first left lane, and a second right lane adjacent to the first right lane. The road horizontal distance may alternatively be a horizontal width of a lane formed by four times a width of the lane where the physical vehicle is located. This is not specifically limited in this application. A road vertical range in the lane change scenario may be a road range formed by a maximum vertical extension lane change distance from the current position. Therefore, the road vertical range data may be the maximum lane change distance, which may be a set value or may be a value calculated based on the road data at the current position. A calculation manner is mentioned later. The road vertical range in the lane change scenario may alternatively be a road range formed by vertically extending from the current position to a predicted lane change landing position. A manner of predicting the lane change landing position is described later.

In an embodiment, the updating a map span and a view angle for displaying the map to a target map span and a target view angle, the target map span and the target view angle being adapted to the road range data includes: determining, based on the road horizontal distance, the target map span required for updating the map, and determining, based on the required target map span and the maximum vertical extension lane change distance, a target skew angle required for updating the map; and updating the map span and the view angle for displaying the map to the target map span and the target skew angle.

In an embodiment, the determining, based on the road horizontal distance, the target map span required for updating the map, and determining, based on the required target map span and the maximum vertical extension lane change distance, a target skew angle required for updating the map includes: determining, based on the road horizontal distance, a map span required for updating the map; obtaining a maximum speed limit of a first lane; calculating the maximum vertical extension lane change distance based on the maximum speed limit and lane change duration; calculating a skew angle based on the required map span and the maximum vertical extension lane change distance; and increasing the required map span when the skew angle is greater than or equal to a preset threshold, and continuing to perform the operation of calculating a skew angle based on the required map span and the maximum vertical extension lane change distance, until the skew angle is less than the preset threshold, to obtain the target map span and the target skew angle required for updating the map.

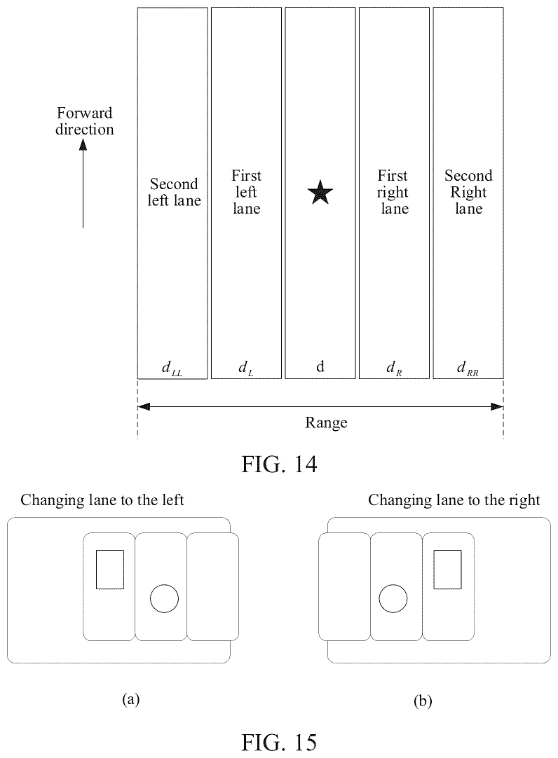

In an exemplary embodiment, the road horizontal range in the lane change scenario is formed by the lane (which may be denoted as the first lane) where the physical vehicle is located, first left and right lanes adjacent to the first lane, a second left lane adjacent to the first left lane, and a second right lane adjacent to the first right lane in the target road, to ensure that information of each lane can be fully presented in the map. FIG. 14 shows the road horizontal range in the lane change scenario. The range is formed by the widths of the lanes, and Range=dLL+dL+d+dR+dRR.

For a position without a second left lane or a second right lane, a map span range may be reduced by dLL or dRR. To be specific, Range=dL+d+dR+dRR or Range=dLL+dL+d+dR.

For a position without a first left lane of a first right lane, a first lane width may be added on the left or right during calculation. To be specific:
when there is no first left lane, Range=d+d+dR+dRR; or
when there is no first right lane, Range=dLL+dL+d+d.

Subsequently, the terminal may determine an initial scale level, that is, an initial map span, by querying Table 1.

Based on the skew angle, a road vertical range that the map can present at a current scale level is determined. In some exemplary embodiments, the road vertical range is related to a maximum speed limit of a current lane. For example, a maximum speed limit of the first lane is V kilometers per hour, that is (V/3.6) meters per second, and lane change duration is 3 seconds, so that a forward display distance is 3*V/3.6. For example, when a current road includes three lanes, widths of the three lanes are the same, and the width of each lane is 3.5 meters. Correspondingly, the road horizontal range data in the lane change scenario is: 3.5*4=14 meters. The maximum speed limit of the first lane is 100 km/h, and the road vertical range data is 3*100/3.6, that is, 83.4 meters, extending vertically from the position of the ego vehicle. It can be learned with reference to Table 1 that the initial map span is 15 meters corresponding to level 21.5. In a case of a scale level of 21.5, the skew angle is calculated to be 80°. Assuming that the preset threshold is 75°, the map span needs to be increased to 20 meters, and the skew angle is calculated to be 76.5°, so that the map span needs to be increased again to 30 meters, and the skew angle is calculated to be 70.2°, which satisfies the requirement. It may be determined that the target map span of the updated map that needs to be displayed at the current position is 30 meters, and the target skew angle is 70.2°.

In this embodiment, the target map span and the target skew angle required for updating the map are determined based on the lane horizontal distance and the lane vertical distance that need to be paid attention to at the current position in the lane change scenario. This can assist a passenger in the physical vehicle in feeling that the passenger is currently in the lane change scenario. The displayed map can focus on the lane range at the current position in the lane change scenario to improve perceptibility for the scenario and improve trustworthiness of the passenger on the autonomous driving system.

In an embodiment, the target road includes a plurality of lanes, the virtual vehicle is displayed in a first lane among the plurality of lanes, and the method further includes: displaying, when the target traveling scenario at the current position of the physical vehicle is a lane change scenario from the first lane to a second lane, the second lane and an estimated landing position of the physical vehicle in the second lane in the center of an updated map.

For example, when the physical vehicle changes a lane from the first lane (also referred to as the current lane) to the left to the second lane, the second lane on the left side of the map is displayed in the center. When the physical vehicle changes a lane from the first lane to the right to the second lane, the second lane on the right side of the map is displayed in the center. In one embodiment, when the travel scenario of the vehicle is switched from the straight-forward traveling scenario to the lane change scenario, the position of the virtual vehicle on the map may change from being below the lane in the map to being above or in the middle of the lane in the map. The terminal may determine an offset of the map and display the map based on the offset to display a road condition of the second lane behind. As shown in FIG. 15, section (a) and section (b) of FIG. 15 are schematic diagrams of a lane change scenario of changing a lane to the left and a lane change scenario of changing a lane to the right, respectively. The outer frame represents an entire vehicle navigation interface, the three rectangular frames represent three lanes, the circle represents a position of an ego vehicle, and the rectangular frame within the lane represents an estimated landing position of a virtual vehicle. A second lane and the estimated landing position on the second lane may be displayed in the center of the vehicle navigation interface.

For the physical vehicle traveling in the first lane, the terminal may obtain the current position of the physical vehicle and vehicle steering information from the autonomous driving domain, and determine, based on the vehicle steering information and a topology of the target road at the current position of the vehicle, the second lane which the physical vehicle changes to.

In an embodiment, the method further includes: obtaining a road topology of the target road at the current position; determining the second lane based on a lane change direction of the lane change scenario and the road topology; calculating an estimated lane change distance based on traveling speed of the physical vehicle and lane change duration when lane change is initiated; determining a vertical distance from the physical vehicle to a center line of the second lane when the lane change is initiated; and determining the estimated landing position of the physical vehicle in the second lane based on the estimated lane change distance and the vertical distance.

Specifically, the terminal obtains the current position of the physical vehicle and determines the first lane where the current position is located, queries a front lane, a rear lane, a left lane and a right lane of the first lane based on the road topology of the target road where the first lane is located, and determines, with reference to the vehicle steering information (changing a lane to the left or changing a lane to the right), the second lane which the physical vehicle changes to. In the autonomous driving scenario, the terminal may obtain steering information of the physical vehicle at the current position from the autonomous driving domain through cross-domain communication.

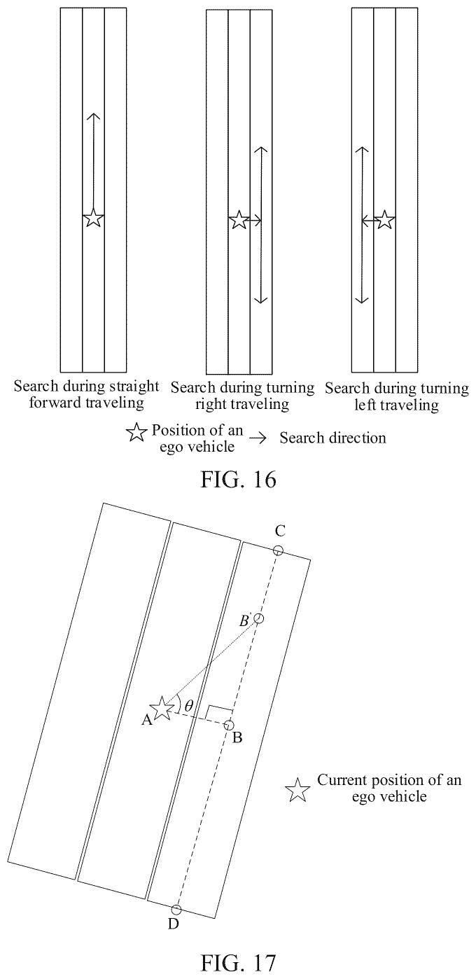

FIG. 16 is a schematic diagram of searching for a second lane in a lane change scenario according to an embodiment. Referring to FIG. 16, when the vehicle turns right, the terminal receives information of changing lanes to the right from the autonomous driving system, obtains second lane information on the right by performing topology processing from the first lane to the right, and searches forward and backward based on the second lane on the right to determine a boundary line and a lane center line of the entire second lane. When the vehicle turns left, which is a scenario of changing lanes to the left, the terminal receives information of changing lanes to the left from the autonomous driving system, obtains second lane information on the left by performing topology processing from the first lane to the left, and searches forward and backward based on the second lane on the left to determine a boundary line and a lane center line of the entire second lane.

FIG. 17 is a schematic diagram of calculating an estimated landing position of a physical vehicle according to an embodiment. Referring to FIG. 17, A represents a current position of an ego vehicle, and CD is a center line of a second lane. A vertical line is drawn from the point A to the straight line CD, with a foot of the vertical line being B. The point B is not an actual landing position. To calculate the landing position, lane change duration and traveling speed of the ego vehicle need to be considered. A specific calculation method is as follows.

It is assumed that the traveling speed of the ego vehicle during lane changing is v m/s, the lane change duration is 3 seconds, and a steering angle is an angle B′AB, that is, θ. A position of B′ on the second lane is obtained by adding, based on a position of the point B, a distance BB′ traveled during lane changing.

$$B {B}^{′} = A {B}^{′} * sin ( {∠B}^{′} AB ) = v * 3 * sin ( θ ) .$$

A position of the foot point B of the vertical line may be determined based on coordinates of the ego vehicle (the current position) and a length of a vertical distance AB. The steering angle of the vehicle may be obtained based on vehicle state data monitored by a sensing device on the vehicle. The estimated lane change distance AB is calculated based on the traveling speed v of the vehicle and the lane change duration when the lane change is initiated, so that the distance BB′ can be calculated based on the foregoing formula. Coordinates of the estimated landing position can be obtained based on the position of the foot B of the vertical line and the distance BB′, and the estimated landing position can be displayed on the vehicle navigation interface based on the coordinates. The estimated landing position may be displayed in the middle of the vehicle navigation interface, or may be displayed at a slightly upper position. The estimated landing position remains unchanged, and the ego vehicle is displayed to gradually approach the estimated landing position as traveling.

In an embodiment, the determining, when the physical vehicle travels to the current position and is in the target traveling scenario, road range data corresponding to the target traveling scenario and the current position includes: determining, based on the current position, when the physical vehicle travels to the current position and is in an avoidance scenario of avoiding an obstacle, a lane horizontal width of a lane where the physical vehicle is located and a lane horizontal width of an adjacent lane of the lane where the physical vehicle is located, calculating a road horizontal distance required for the avoidance scenario based on the lane horizontal width of the lane where the physical vehicle is located and the lane horizontal width of the adjacent lane of the lane where the physical vehicle is located, and calculating a maximum distance between the current position and the obstacle; and updating a map span and a view angle for displaying the map to a target map span and a target view angle, the target map span and the target view angle being adapted to the road range data, including: determining, based on the road horizontal distance, the target map span required for updating the map, and determining, based on the required target map span and the maximum distance between the current position and the obstacle, a target skew angle required for updating the map; and updating the map span and the view angle for displaying the map to the target map span and the target skew angle.

The avoidance scenario is a scenario in which the vehicle needs to decelerate, change a lane, or the like to avoid a dangerous situation when encountering an obstacle during traveling, such as a vehicle overtaking, a vehicle in front decelerating, or a vehicle in front changing a lane, resulting in a poor road condition in a current lane. In the avoidance scenario, it is necessary to focus on the obstacle and a lane where the obstacle is located. The lane where the obstacle is located is usually an adjacent lane of the lane where the ego vehicle is located.

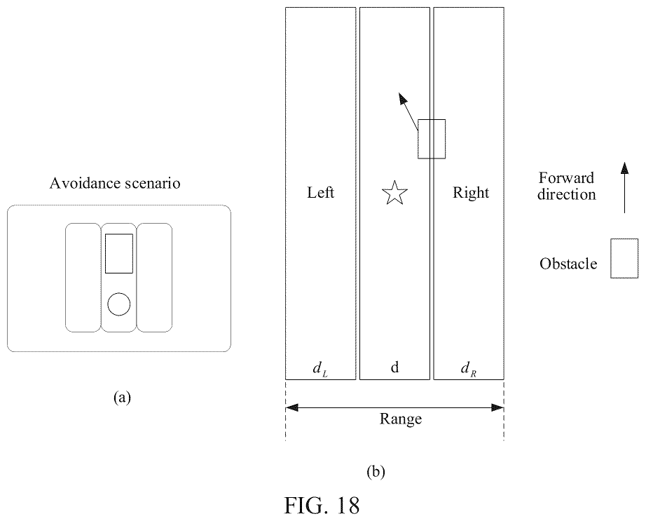

As shown in FIG. 18, section (a) of FIG. 18 is a schematic diagram of an avoidance scenario according to an embodiment. Referring to section (a) of FIG. 18, the outer frame represents an entire vehicle navigation interface, the three rectangular frames represent three lanes, the circle represents a position of an ego vehicle, and the rectangular frame represents a position of an obstacle. In an embodiment, in an avoidance scenario, the vehicle may be displayed on the map below the lane where the vehicle is located to better present obstacles ahead or on both sides. In the avoidance scenario, the terminal determines the target map span and the target view angle based on the position of the obstacle and the position of the ego vehicle, so that the displayed map can focus on details of the avoidance scenario.

In the avoidance scenario, information about traffic participants in the lane where the ego vehicle is located and the left and right adjacent lanes is focused. In this case, the road horizontal range may be a road horizontal distance at the current position when the physical vehicle is in the avoidance scenario. The road horizontal distance may be a road width of the target road. In a case that the target road includes a plurality of lanes, the road horizontal distance may be a horizontal width of lanes formed by the lane where the physical vehicle is located and left and right adjacent lanes of the lane, or may be a horizontal width of a minimum rectangular area where the physical vehicle and the obstacle are located, which is not specifically limited in this application. A road vertical range in the avoidance scenario may be a lane vertical range from the current position to the obstacle.

In an embodiment, the determining, based on the road horizontal distance, the target map span required for updating the map, and determining, based on the required target map span and the maximum distance between the current position and the obstacle, a target skew angle required for updating the map includes: determining, based on the lane horizontal distance, a map span required for updating the map; calculating a skew angle based on the required map span and the maximum distance between the current position and the obstacle; and increasing the required map span when the skew angle is greater than or equal to a preset threshold, and continuing to perform the operation of calculating a skew angle based on the required map span and the maximum distance between the current position and the obstacle, until the skew angle is less than the preset threshold, to obtain the target map span and the target skew angle required for updating the map.

Specifically, the terminal determines the adjacent lanes of the lane where the physical vehicle is located in the target road; determines, based on the lane horizontal distance formed by the lane where the physical vehicle is located and the adjacent lanes, the map span required for updating the map; determines a maximum distance between the physical vehicle and the obstacle; calculates the skew angle based on the required map span and the maximum distance; and increases the required map span when the skew angle is greater than or equal to the preset threshold, and continues to perform the operation of calculating the skew angle based on the required map span and the maximum distance, until the skew angle is less than the preset threshold, to obtain the target map span and the target skew angle required for updating the map.

Section (b) of FIG. 18 is a schematic diagram of an avoidance scenario according to an embodiment. In the avoidance scenario, information about traffic participants in a lane where the ego vehicle travels and left and right adjacent lanes is focused. The rectangular block in section (b) of FIG. 18 represents an obstacle entering from the adjacent lane, the arrow indicates a traveling direction of the obstacle, and & represents a current position of an ego vehicle. At a current position shown in section (b) of FIG. 18, the lane horizontal distance Range=dL+d+dR in the avoidance scenario. Subsequently, the terminal may determine, based on Range, an initial scale level, that is, an initial map span, by querying Table 1.

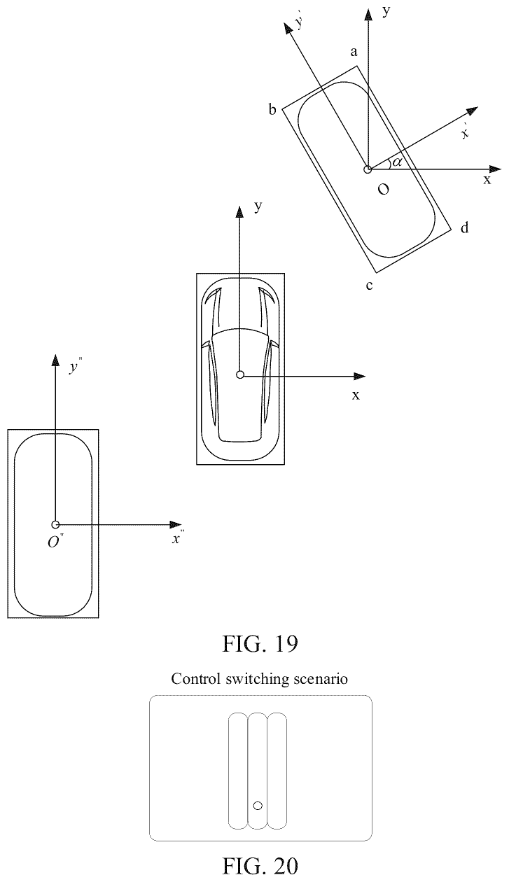

To clearly present a lane range between the ego vehicle and the obstacle, the required skew angle may be determined in the following manner. The terminal may calculate the maximum distance between the ego vehicle and the obstacle. FIG. 19 is a schematic diagram of a position of an ego vehicle and a position of an obstacle according to an embodiment. Referring to FIG. 19, an O-xy coordinate system is established with the center of the ego vehicle as a coordinate origin O, a direction to the right from the ego vehicle as an x-axial direction, and a forward direction of ego vehicle as a y-axial direction. A coordinate system is established with the center of an obstacle (a sensed target) sensed by the ego vehicle as a coordinate origin, a direction to the right from the obstacle as an x′-axis, and a forward direction of the obstacle as a y′-axis. Referring to FIG. 19, an O′-x′y′ coordinate system and an O″-x″y″ coordinate system are coordinate systems established based on two sensed targets. Coordinates of O′ and O″ in the O-xy coordinate system are (Ox′, Oy′) and (Ox “, Oy”), respectively.

The O′-x′y′ coordinate system is used as an example for description. Assuming that a length and a width of the obstacle are h meters and w meters, respectively, a, b, c, and d in the O′-x′y′ coordinate system are (w/2, h/2), (−w/2, h/2), (−w/2, −h/2), and (w/2, h/2), respectively. O′-xy is a state of O-xy translated to the obstacle coordinate system. O′-xy coincides with O-xy after clockwise rotation of α°. It is assumed that the maximum distance between the ego vehicle and the obstacle is a distance between the ego vehicle and a. Coordinates of a in O′-x′y′ are (x′, y′), and coordinates of a in O′-xy are (x, y), so that x=x′*cos(α)-y′*sin(α); and y=y′*cos(α)+x′*sin(α).

The coordinates of a in the O′-xy coordinate system are translated to the O-xy coordinate system to obtain a position of a in the O-xy coordinate system, which is (Ox, Oy), where

$$Ox = {Ox}^{′} + {x}^{′} * cos ( α ) - {y}^{′} * sin ( α ) ; and$$

$$Oy = {Oy}^{′} + {y}^{′} * cos ( α ) + {x}^{′} * sin ( α ) .$$

After the coordinates of the point a are obtained through the foregoing calculation, the distance between the ego vehicle and a can be calculated.

The distance may be used as the road vertical distance at the current position when the physical vehicle in the avoidance scenario in a lane change scenario. For example, in FIG. 18, widths of the three lanes are the same, and the width of each lane is 3.5 meters, so that the road horizontal range in the avoidance scenario is 3.5*4=14 meters. The road vertical range data is the maximum distance between the position of the ego vehicle and the obstacle. It is assumed that a calculated maximum distance is 10 meters and a preset threshold of the skew angle is 75°. It can be learned with reference to Table 1 that the initial map span is 15 meters corresponding to level 21.5. In a case of a scale level of 21.5, the skew angle is calculated to be 33.8°, which satisfies the requirement. It may be determined that the target map span and the target skew angle of a to-be-updated map at the current position are 15 meters and 33.8°, respectively.

In this embodiment, the target map span and the target skew angle required for updating the map are determined based on the lane horizontal distance and the lane vertical distance that need to be paid attention to at the current position of the physical vehicle in the avoidance scenario. This can assist a passenger in the vehicle in feeling that the passenger is currently in the avoidance scenario. The displayed map can focus on the ego vehicle and the obstacle in the avoidance scenario to improve perceptibility for the scenario.

In an embodiment, the determining, when the physical vehicle travels to the current position and is in the target traveling scenario, road range data corresponding to the target traveling scenario and the current position includes: calculating, when the physical vehicle travels to the current position and is in a control switching scenario from a control switching prompt position to an autonomous driving exit position, lane horizontal distances at the current position and in the control switching scenario based on road data of the target road where the current position is located and road data of a road where the autonomous driving exit position is located, and calculating a distance from the current position to the autonomous driving exit position; and updating a map span and a view angle for displaying the map to a target map span and a target view angle, the target map span and the target view angle being adapted to the road range data, including: determining, based on the road horizontal distance, the target map span required for updating the map, and determining, based on the required target map span and the distance from the current position to the autonomous driving exit position, a target skew angle required for updating the map; and updating the map span and the view angle for displaying the map to the target map span and the target skew angle.

The control switching scenario is a scenario in which an autonomous driving vehicle is about to leave an area supported by an autonomous driving function and is about to be switched to manual driving. In the autonomous driving control switching scenario, it is necessary to focus on a position on a road where an autonomous driving is exited. A road range in the control switching scenario is a road range from the current position to the autonomous driving exit position in the target road. When traveling to the control switching prompt position, the physical vehicle is considered to be in the control switching scenario. The control switching prompt position is a position that the vehicle passes when the vehicle is about to reach the autonomous driving exit position. The position is a specific distance away from the autonomous driving exit position, for example, which may be 2.5 kilometers. In a case that the distance between the current position of the physical vehicle and the autonomous driving exit position is far, for example, 2 kilometers, to present the autonomous driving exit position on the vehicle navigation interface, the target map span for displaying the map needs to be much larger than the horizontal width of the target road where the vehicle is located. In a case that the distance between the current position of the physical vehicle and the autonomous driving exit position is short, for example, 20 meters, to present a road condition between the physical vehicle and the autonomous driving exit position as clearly as possible, the target map span for displaying the map is small. It can be learned that, in an autonomous driving control switching scenario, during physical vehicle moving, the target map span required for displaying the map is first increased until the autonomous driving exit position can be observed, and then the ego vehicle and the exit position are kept visible all the time and the map span is gradually zoomed out.

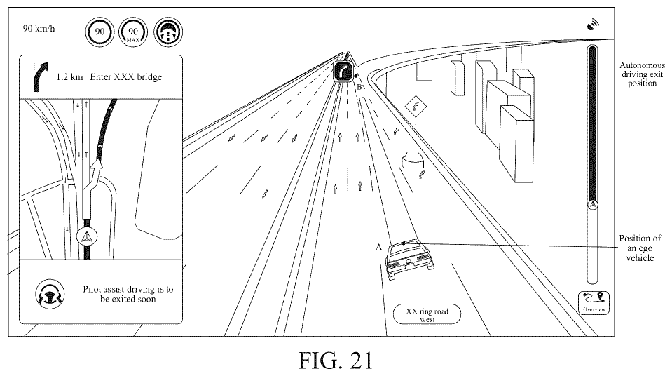

FIG. 20 is a schematic diagram of an autonomous driving control switching scenario according to an embodiment. It can be learned that, in the autonomous driving control switching scenario, to keep an autonomous driving exit position visible all the time, a map span of a map displayed in the autonomous driving control switching scenario is smaller than a map span of a map displayed in a straight-forward traveling scenario. FIG. 21 is a diagram of a rendering effect of an autonomous driving control switching scenario according to an embodiment. A represents a position of an ego vehicle, B represents an autonomous driving exit position, and an AB interval is an area in which a manual control switch prompt is to be given.

In an embodiment, the determining, based on the road horizontal distance, the target map span required for updating the map, and determining, based on the required target map span and the distance from the current position to the autonomous driving exit position, a target skew angle required for updating the map includes: determining, based on the lane horizontal distance, a map span required for updating the map; calculating a skew angle based on the required map span and the distance from the current position to the autonomous driving exit position; and increasing the required map span when the skew angle is greater than or equal to a preset threshold, and continuing to perform the operation of calculating a skew angle based on the required map span and the distance from the current position to the autonomous driving exit position, until the skew angle is less than the preset threshold, to obtain the target map span and the target skew angle required for updating the map.

Specifically, operations for determining the target map span and the target skew angle in the control switching scenario include: determining the lane horizontal distance formed between the target road and the road where the autonomous driving exit position is located, and determining, based on the lane horizontal distance, the map span required for updating the map; calculating the distance from the current position to the autonomous driving exit position; calculating the skew angle based on the required map span and the distance; and increasing the required map span when the skew angle is greater than or equal to the preset threshold, and continuing to perform the operation of calculating a skew angle based on the required map span and the distance, until the skew angle is less than the preset threshold, to obtain the target map span and the target skew angle required for updating the map.

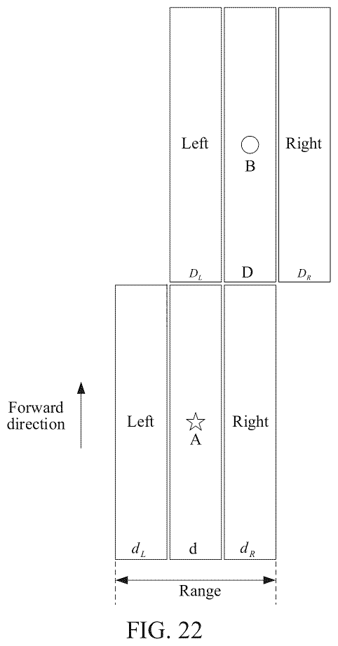

FIG. 22 is a schematic diagram of a road range in a control switching scenario according to an embodiment. Referring to FIG. 22, a road horizontal range in the control switching scenario is a multi-lane range formed by a lane where a point B is located and left and right lanes of the lane, as well as a lane where a point A is located and left and right lanes of the lane. The road horizontal range is denoted by Range in FIG. 22. Certainly, if there is no left lane or right lane at point A or point B, a lane width may be supplemented based on the lane where point A is located to form the road horizontal range. A road vertical range in the control switching scenario is a distance between the point A and the point B. The terminal receives the autonomous driving exit position in the current control switching scenario sent by an autonomous driving domain through cross-domain communication, and displays the autonomous driving exit position on a map based on the position.

For example, in FIG. 22, assuming that lane widths are the same and the width of each lane is 3.5 meters, the road horizontal range in the control switching scenario, that is, the multi-lane range, is 3.5*4=14 meters. It is assumed that the distance from the current position to the autonomous driving exit position is 1000 meters and the preset threshold of the skew angle is 75°. It can be learned with reference to Table 1 that the initial map span is 15 meters corresponding to level 21.5. In a case of a scale level of 21.5, the skew angle is calculated to be greater than 75° based on 15 meters and 1000 meters, which does not satisfy the requirement. The map span is gradually increased until the map span is 312 meters, and the skew angle is calculated to be 72.6°, which satisfies the requirement. It may be determined that the target map span and the target skew angle required for updating the map at the current position of the physical vehicle are 312 meters and 72.6°, respectively.

In this embodiment, the target map span and the target skew angle required for updating the map are determined based on the lane vertical distance that needs to be paid attention to at the current position of the physical vehicle in the control switching scenario. This can assist a passenger in the physical vehicle in feeling that the passenger is currently in the control switching scenario. The displayed map can focus on the autonomous driving exit position in the control switching scenario to improve perceptibility for the scenario.

In an embodiment, the determining, when the physical vehicle travels to the current position and is in the target traveling scenario, road range data corresponding to the target traveling scenario and the current position includes: extending, when the physical vehicle travels to the current position and is in a maneuver position scenario of traveling in a maneuver operation area of a target maneuver position, a preset distance along intersection extension directions of the target maneuver position, based on an intersection width of a road where the target maneuver position is located, to obtain a road horizontal distance and a road vertical distance in the maneuver position scenario; and updating a map span and a view angle for displaying the map to a target map span and a target view angle, the target map span and the target view angle being adapted to the road range data, including: determining, based on the road horizontal distance, the target map span required for updating the map, and determining, based on the required target map span and the road vertical distance, a target skew angle required for updating the map.

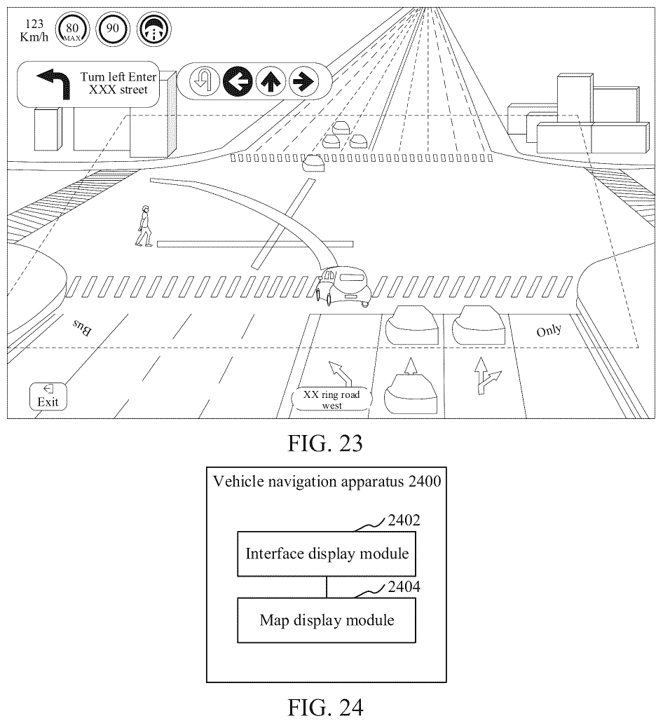

The maneuver position scenario refers to a location where the physical vehicle performs maneuvers such as turning or turning around during traveling. In the maneuver position scenario, it is necessary to focus on a road condition of a maneuver position ahead. In an embodiment, when a distance between the physical vehicle and a specific maneuver position scenario is less than a specific threshold, it is determined that the physical vehicle enters a maneuver area of the maneuver position. In other words, the physical vehicle is in the maneuver position scenario. In the maneuver position scenario, the terminal displays a map with an increased map span and a reduced skew angle to present a traffic condition of the entire maneuver position. In other words, a road range at the current position when the physical vehicle is in the maneuver position scenario is a range where the maneuver position ahead is located. FIG. 23 is a schematic diagram of a rendering effect of a maneuver position scenario in an autonomous driving scenario. A maneuver position in FIG. 23 is an intersection. A horizontal distance and a vertical distance corresponding to a road range are intersection widths, as shown in a dotted rectangular box in FIG. 23. To include more information, specific distances may be extended in intersection extension directions as the road range based on the intersection, so that the road range extended in the intersection extension directions by specific distances is presented in the map in this scenario.

In an embodiment, the determining, based on the road horizontal distance, the target map span required for updating the map, and determining, based on the required target map span and the road vertical distance, a target skew angle required for updating the map includes: determining, based on the road horizontal distance, a map span required for updating the map; calculating a skew angle based on the required map span and the road vertical distance; and increasing the required map span when the skew angle is greater than or equal to a preset threshold, and continuing to perform the operation of calculating a skew angle based on the required map span and the road vertical distance, until the skew angle is less than the preset threshold, to obtain the target map span and the target skew angle required for updating the map.

Specifically, operations for determining the target map span and the target skew angle in the maneuver position scenario include: determining a road horizontal distance and a road vertical distance of the target maneuver position, determining, based on the road horizontal distance, the map span required for updating the map, calculating the skew angle based on the required map span and the road vertical distance, increasing the required map span when the skew angle is greater than or equal to the preset threshold, and continuing to perform the operation of calculating a skew angle based on the required map span and the road vertical distance, until the skew angle is less than the preset threshold, to obtain the target map span and the target skew angle required for updating the map.

For example, in the maneuver position scenario shown in FIG. 23, a width of the intersection is 25 meters, and the distance from the current position to the front intersection is 50 meters. The road range may be obtained by extending by 10 meters in the intersection extension directions, so that the road horizontal range in the maneuver position scenario is 35 meters, and the road vertical range is 60 meters. It can be learned with reference to Table 1 that the initial map span is 39 meters corresponding to level 20. In a case of a scale lever of 20, the skew angle is calculated to be 56.97°. It can be determined that the target map span and the target skew angle required for displaying the map at the current position are 39 meters and 56.97°, respectively.

In this embodiment, the target map span and the target skew angle required for displaying the map are determined based on the lane horizontal distance and the lane vertical distance that need to be paid attention to at the current position of the physical vehicle in the maneuver position scenario. This can assist a passenger in the physical vehicle in feeling that the passenger is currently in the maneuver position scenario. The displayed map can focus on the lane range at the current position in the maneuver position scenario to improve perceptibility for the scenario and improve trustworthiness of the passenger on the autonomous driving system.

In an embodiment, the terminal may first enter an autonomous driving state when the physical vehicle is in the autonomous driving state. When the vehicle is in the straight-forward traveling scenario, the terminal may execute a strategy for adjusting the map span and the skew angle of the map in the straight-forward traveling scenario. When the physical vehicle is in an autonomous lane change scenario at the current position, the terminal executes a strategy for adjusting the map span and the skew angle of the map in the lane change scenario and returns to the straight-forward traveling scenario after the physical vehicle completes or cancels lane change. When the physical vehicle is in an autonomous avoidance scenario at the current position, the terminal executes a strategy for adjusting the map span and the skew angle of the map in the autonomous avoidance scenario and returns to the straight-forward traveling scenario after the physical vehicle completes or cancels avoidance. When the physical vehicle is about to exit autonomous driving and enter the control switching scenario at the current position, the terminal executes a strategy for adjusting the map span and the skew angle of the map in the control switching scenario, enters an SD navigation scenario after the physical vehicle completes control switching, and starts to execute a map span adjustment strategy of SD navigation. When states conflict, the map span does not change, and a map span adjustment strategy of a previous scenario is maintained. For example, if an autonomous avoidance task is inserted during autonomous lane change, an adjustment strategy of the autonomous lane change scenario is maintained. When the lane change scenario is switched to another lane change scenario, states do not conflict, and switching to an adjustment strategy of the control switching scenario can be directly performed.

In embodiments of this application, a method for automatic adjustment of a graphics effect based on a high definition map and a driving state in the autonomous driving scenario is provided, in which data such as a lane length, a road width, and a road topology relationship in the high definition map are used as input of an autonomous adjustment strategy. In addition, with reference to application scenarios such as straight-forward traveling, lane change, yielding, avoiding, and control switching outputted by an autonomous driving system, parameters such as the map span and the skew angle of the map, and a position indicated by a center point of the map are comprehensively adjusted to achieve a purpose of autonomous adjustment of the graphics effect. This method greatly improves quality of a navigation map, increases map reading speed, and improves navigation experience, further assists the passenger in the vehicle in understanding a decision-making action of the autonomous driving system, and improves trustworthiness of the passenger in the vehicle on the autonomous driving system.

In embodiments, the target map span and the target view angle required for displaying the map are determined based on an actual road condition of the target road at the current position of the physical vehicle and the traveling scenario at the current position of the physical vehicle, so that the road range displayed on the map is adapted to a road area that needs to be paid attention to in the traveling scenario of the position of the physical vehicle. This can improve perceptibility for a map change, greatly improve quality of navigation map, increase map reading speed, and improve navigation experience. In addition, based on the target view angle of the updated map, a visible range of the map can be expanded when the target map span is small, to improve navigation efficiency.

Although the operations are displayed sequentially according to the instructions of the arrows in the flowcharts of the foregoing embodiments, these operations are not necessarily performed sequentially according to the sequence instructed by the arrows. Unless otherwise explicitly specified in this application, execution of the operations is not strictly limited, and the operations may be performed in other sequences. In addition, at least some operations in the flowcharts of the foregoing embodiments may include a plurality of operations or a plurality of stages, and these operations or stages are not necessarily performed at a same time instant, and may be performed at different time instants. These operations or stages are not necessarily performed in sequence, and the operations or stages may be performed alternately with at least some of other operations, operations or stages of other operations.

Based on the same inventive concept, an embodiment of this application further provides a vehicle navigation apparatus for implementing the foregoing vehicle navigation method. An implementation for resolving problems provided in the apparatus is similar to the implementation described in the foregoing method. Therefore, reference may be made to the foregoing limitations to the vehicle navigation method, for specific limitations of the following one or more vehicle navigation apparatus embodiments, which is not limited herein.

In an embodiment, as shown in FIG. 24, a vehicle navigation apparatus 2400 is provided and includes: an interface display module 2402 and a map display module 2404.

The interface display module 2402 is configured to display a vehicle navigation interface for navigating a physical vehicle, where the vehicle navigation interface includes a map.

The map display module 2404 is configured to: display a virtual vehicle on a target road on the map, where the virtual vehicle corresponds to the physical vehicle, determine, when the physical vehicle travels to a current position and is in a target traveling scenario, road range data corresponding to the target traveling scenario and the current position; and update a map span and a view angle for displaying the map to a target map span and a target view angle, where the target map span and the target view angle are adapted to the road range data.

All or some of the modules in the foregoing vehicle navigation apparatus may be implemented by using software, hardware, or a combination thereof. Each module can be embedded in or independent of a processor in a computer device in a form of hardware, or can be stored in a memory in the computer device in a form of software, so that the processor can be called to perform corresponding operations of each of the foregoing modules.

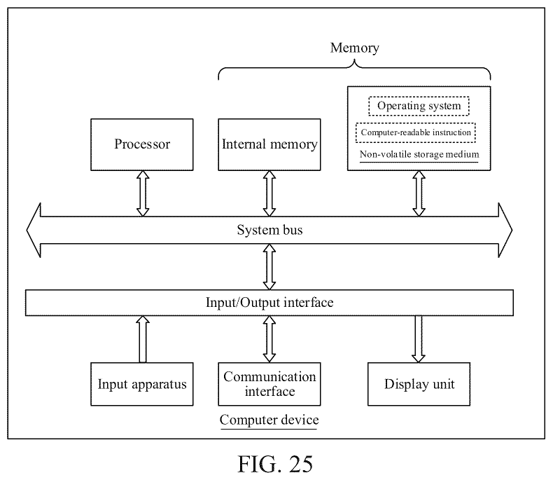

In an embodiment, a computer device is provided. The computer device may be the terminal 102 in FIG. 1 or the on-board terminal 604 in FIG. 6. A diagram of an internal structure of the computer device may be shown in FIG. 25. The computer device includes a processor, a memory, an input/output interface, a communication interface, a display unit, and an input apparatus. The processor, the memory, and the input/output interface are connected via a system bus. The communication interface, the display unit, and input apparatus are connected to the system bus via the input/output interface. The processor of the computer device is used for providing computing and control capabilities. The memory of the computer device includes a non-volatile storage medium and an internal memory. The non-volatile storage medium stores an operating system and computer-readable instructions. The internal memory provides an environment for running of the operating system and the computer-readable instructions in the non-volatile storage medium. The input/output interface of the computer device is configured to exchange information between the processor and an external device. The communication interface of the computer device is configured to communicate with an external terminal in a wired or wireless manner. The wireless manner may be implemented by WIFI, a mobile cellular network, near field communication (NFC), or another technology. The computer-readable instructions, when executed by the processor, implement a vehicle navigation method. The display unit of the computer device is configured to form a visually visible picture, and may be a display screen, a projection device, or a virtual reality imaging apparatus. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, a touchpad, a mouse or the like. An input interface of the computer device may receive data sent from a positioning device or a sensing device on a vehicle, including vehicle position data, obstacle position data, obstacle orientation data relative to the ego vehicle, and the like.

A person skilled in the art may understand that, the structure shown in FIG. 25 is merely a block diagram of a partial structure related to a solution in this application, and does not constitute a limitation to the computer device to which the solution in this application is applied. Specifically, the computer device may include more components or fewer components than those shown in the figure, or some components may be combined, or a different component deployment may be used.

In an embodiment, a computer device is further provided, and includes a memory and a processor. The memory has computer-readable instructions stored therein. When executing the computer-readable instructions, the processor implements operations of the vehicle navigation method described in any one or more of the foregoing embodiments.

In an embodiment, a computer-readable storage medium is provided, having computer-readable instructions stored thereon, the computer-readable instructions, when executed by a processor, implementing operations of the vehicle navigation method described in any one or more of the foregoing embodiments.

In an embodiment, a computer program product is provided, including computer-readable instructions, the computer-readable instructions, when executed by a processor, implementing operations of the vehicle navigation method described in any one or more of the foregoing embodiments.

User information (including but not limited to user device information, user personal information, and the like) and data (including but not limited to data used for analysis, stored data, displayed data, and the like), included in this application are information and data that all authorized by a user or fully authorized by all parties. Collection, use, and processing of related data need to comply with relevant laws, regulations, and standards of relevant countries and regions.

A person of ordinary skill in the art may understand that all or some of procedures of the method in the foregoing embodiments may be implemented by instructing relevant hardware by using computer-readable instructions. The computer-readable instructions may be stored in a non-volatile computer-readable storage medium. When the computer-readable instructions are executed, the processes of the embodiments of the methods may be included. Any reference to the memory, database or another medium used in the embodiments provided in this application may include at least one of a non-volatile and a volatile memory. The non-volatile memory may include a read-only memory (ROM), a magnetic tape, a floppy disk, a flash memory, an optical memory, a high-density embedded non-volatile memory, a resistive memory (ReRAM), a magnetoresistive random access memory (MRAM), a ferroelectric random access memory (FRAM), a phase change memory (PCM), a graphene memory, and the like. The volatile memory may include a random access memory (RAM) or an external cache memory, or the like. As an illustration rather than a limitation, RAM may come in many forms, such as static random access memory (SRAM) or dynamic random access memory (DRAM). The database involved in the embodiments provided in this application may include at least one of a relational and non-relational database. The non-relational database may include but is not limited to a blockchain-based distributed database and the like. The processor involved in the embodiments provided in this application may be, but is not limited to, a general purpose processor, a central processing unit, a graphic processing unit, a digital signal processor, a programmable logic device, a quantum computing-based data processing logic device, and the like.

Technical features of the foregoing embodiments may be randomly combined. To make description concise, not all possible combinations of the technical features in the foregoing embodiments are described. However, the combinations of these technical features shall be considered as falling within the scope recorded by this specification provided that no conflict exists.

The foregoing embodiments show only several implementations of this application and are described in detail, which, however, are not to be construed as a limitation to the patent scope of this application. For a person of ordinary skill in the art, several transformations and improvements can be made without departing from the idea of this application. These transformations and improvements belong to the protection scope of this application. Therefore, the protection scope of this application shall be subject to the appended claims.

What is claimed is:

1. A vehicle navigation method, performed by a computer device, and comprising:
displaying a vehicle navigation interface for navigating a physical vehicle, the vehicle navigation interface comprising a map;
displaying a virtual vehicle on a target road on the map, the virtual vehicle corresponding to the physical vehicle;
determining, when the physical vehicle travels to a current position and is in a target traveling scenario, road range data corresponding to the target traveling scenario and the current position; and
updating a map span and a view angle for displaying the map to a target map span and a target view angle, the target map span and the target view angle being adapted to the road range data.

2. The method according to claim 1, wherein the determining, when the physical vehicle travels to a current position and is in a target traveling scenario, road range data corresponding to the target traveling scenario and the current position comprises:
determining road horizontal range data and road vertical range data of the target traveling scenario and the current position when the physical vehicle travels to the current position and is in the target traveling scenario.

3. The method according to claim 2, wherein the updating a map span and a view angle for displaying the map to a target map span and a target view angle, the target map span and the target view angle being adapted to the road range data comprises:
determining, based on the road horizontal range data at the current position when the physical vehicle is in the target traveling scenario and the road vertical range data at the current position when the physical vehicle is in the target traveling scenario, the target map span and the target view angle required for updating the map; and
displaying the map as a map comprising the target map span and the target view angle.

4. The method according to claim 3, wherein the determining, based on the road horizontal range data at the current position when the physical vehicle is in the target traveling scenario and the road vertical range data at the current position when the physical vehicle is in the target traveling scenario, the target map span and the target view angle required for updating the map comprises:
determining, based on the road horizontal range data at the current position when the physical vehicle is in the target traveling scenario, a map span required for updating the map;
determining, based on the required map span and the road vertical range data at the current position when the physical vehicle is in the target traveling scenario, a skew angle required for updating the map; and
increasing the required map span when the skew angle is greater than or equal to a preset threshold, and continuing to perform the operation of determining, based on the required map span and the road vertical range data at the current position when the physical vehicle is in the target traveling scenario, a skew angle required for updating the map, until the skew angle is less than the preset threshold, to obtain the target map span and the target view angle required for updating the map.

5. The method according to claim 1, wherein the target road comprises a plurality of lanes, the virtual vehicle is displayed in a first lane among the plurality of lanes, and the method further comprises:
updating, when the physical vehicle is in a straight-forward traveling scenario at the current position to which the physical vehicle travels, the map span and the view angle for displaying the map to a set map span and a set view angle in the straight-forward traveling scenario; and
displaying, in the center of a map updated in the straight-forward traveling scenario, the first lane in which the virtual vehicle is displayed.

6. The method according to claim 1, wherein the determining, when the physical vehicle travels to a current position and is in a target traveling scenario, road range data corresponding to the target traveling scenario and the current position comprises:
calculating, based on road data at the current position, when the physical vehicle travels to the current position and is in a lane change scenario, a road horizontal distance required for the lane change scenario, and calculating, based on the road data at the current position, a maximum vertical extension lane change distance required for lane change from the current position; and
the updating a map span and a view angle for displaying the map to a target map span and a target view angle, the target map span and the target view angle being adapted to the road range data comprises:
determining, based on the road horizontal distance, the target map span required for updating the map, and determining, based on the required target map span and the maximum vertical extension lane change distance, a target skew angle required for updating the map; and
updating the map span and the view angle for displaying the map to the target map span and the target skew angle.

7. The method according to claim 6, wherein the target road comprises a plurality of lanes, the virtual vehicle is displayed in a first lane among the plurality of lanes, and the method further comprises:
displaying, when the target traveling scenario of the physical vehicle at the current position is a lane change scenario from the first lane to a second lane, the second lane and an estimated landing position of the physical vehicle in the second lane in the center of an updated map.

8. The method according to claim 7, further comprising:
obtaining a road topology of the target road at the current position;
determining the second lane based on a lane change direction of the lane change scenario and the road topology;
calculating an estimated lane change distance based on traveling speed of the physical vehicle and lane change duration when lane change is initiated;
determining a vertical distance from the physical vehicle to a center line of the second lane when the lane change is initiated; and
determining the estimated landing position of the physical vehicle in the second lane based on the estimated lane change distance and the vertical distance.

9. The method according to claim 6, wherein the determining, based on the road horizontal distance, the target map span required for updating the map, and determining, based on the required target map span and the maximum vertical extension lane change distance, a target skew angle required for updating the map comprises:
determining, based on the road horizontal distance, a map span required for updating the map;
obtaining a maximum speed limit of a first lane;
calculating the maximum vertical extension lane change distance based on the maximum speed limit and lane change duration;
calculating a skew angle based on the required map span and the maximum vertical extension lane change distance; and
increasing the required map span when the skew angle is greater than or equal to a preset threshold, and continuing to perform the operation of calculating a skew angle based on the required map span and the maximum vertical extension lane change distance, until the skew angle is less than the preset threshold, to obtain the target map span and the target skew angle required for updating the map.

10. The method according to claim 1, wherein the determining, when the physical vehicle travels to a current position and is in a target traveling scenario, road range data corresponding to the target traveling scenario and the current position comprises:
determining, based on the current position, when the physical vehicle travels to the current position and is in an avoidance scenario of avoiding an obstacle, a lane horizontal width of a lane where the physical vehicle is located and a lane horizontal width of an adjacent lane of the lane where the physical vehicle is located, calculating, based on the lane horizontal width of the lane where the physical vehicle is located and the lane horizontal width of the adjacent lane of the lane where the physical vehicle is located, a road horizontal distance required for the avoidance scenario and calculating a maximum distance between the current position and the obstacle; and
the updating a map span and a view angle for displaying the map to a target map span and a target view angle, the target map span and the target view angle being adapted to the road range data comprises:
determining, based on the road horizontal distance, the target map span required for updating the map, and determining, based on the required target map span and the maximum distance between the current position and the obstacle, a target skew angle required for updating the map; and
updating the map span and the view angle for displaying the map to the target map span and the target skew angle.

11. The method according to claim 10, wherein the determining, based on the road horizontal distance, the target map span required for updating the map, and determining, based on the required target map span and the maximum distance between the current position and the obstacle, a target skew angle required for updating the map comprises:
determining, based on the road horizontal distance, a map span required for updating the map;
calculating a skew angle based on the required map span and the maximum distance between the current position and the obstacle; and
increasing the required map span when the skew angle is greater than or equal to a preset threshold, and continuing to perform the operation of calculating a skew angle based on the required map span and the maximum distance between the current position and the obstacle, until the skew angle is less than the preset threshold, to obtain the target map span and the target skew angle required for updating the map.

12. The method according to claim 1, wherein the determining, when the physical vehicle travels to a current position and is in a target traveling scenario, road range data corresponding to the target traveling scenario and the current position comprises:
calculating, when the physical vehicle travels to the current position and is in a control switching scenario from a control switching prompt position to an autonomous driving exit position, lane horizontal distances at the current position and in the control switching scenario based on road data of the target road where the current position is located and road data of a road where the autonomous driving exit position is located, and calculating a distance from the current position to the autonomous driving exit position; and
the updating a map span and a view angle for displaying the map to a target map span and a target view angle, the target map span and the target view angle being adapted to the road range data comprises:
determining, based on the road horizontal distance, the target map span required for updating the map, and determining, based on the required target map span and the distance from the current position to the autonomous driving exit position, a target skew angle required for updating the map; and
updating the map span and the view angle for displaying the map to the target map span and the target skew angle.

13. The method according to claim 12, wherein the determining, based on the road horizontal distance, the target map span required for updating the map, and determining, based on the required target map span and the distance from the current position to the autonomous driving exit position, a target skew angle required for updating the map comprises:
determining, based on the road horizontal distance, a map span required for updating the map;
calculating a skew angle based on the required map span and the distance from the current position to the autonomous driving exit position; and
increasing the required map span when the skew angle is greater than or equal to a preset threshold, and continuing to perform the operation of calculating a skew angle based on the required map span and the distance from the current position to the autonomous driving exit position, until the skew angle is less than the preset threshold, to obtain the target map span and the target skew angle required for updating the map.

14. The method according to claim 1, wherein the determining, when the physical vehicle travels to a current position and is in a target traveling scenario, road range data corresponding to the target traveling scenario and the current position comprises:
extending, when the physical vehicle travels to the current position and is in a maneuver position scenario of traveling in a maneuver operation area of a target maneuver position, a preset distance along intersection extension directions of the target maneuver position, based on an intersection width of a road where the target maneuver position is located, to obtain a road horizontal distance and a road vertical distance in the maneuver position scenario; and
the updating a map span and a view angle for displaying the map to a target map span and a target view angle, the target map span and the target view angle being adapted to the road range data comprises:
determining, based on the road horizontal distance, the target map span required for updating the map, and determining, based on the required target map span and the road vertical distance, a target skew angle required for updating the map; and

15. The method according to claim 14, wherein the determining, based on the road horizontal distance, the target map span required for updating the map, and determining, based on the required target map span and the road vertical distance, a target skew angle required for updating the map comprises:
determining, based on the road horizontal distance, a map span required for updating the map;
calculating a skew angle based on the required map span and the road vertical distance; and
increasing the required map span when the skew angle is greater than or equal to a preset threshold, and continuing to perform the operation of calculating a skew angle based on the required map span and the road vertical distance, until the skew angle is less than the preset threshold, to obtain the target map span and the target skew angle required for updating the map.

16. A vehicle navigation apparatus, comprising:
a memory storing a plurality of computer-readable instructions; and
a processor configured to execute the plurality of computer-readable instructions, wherein upon execution of the plurality of computer-readable instructions, the processor is configured to:
display, via a display, a vehicle navigation interface for navigating a physical vehicle, the vehicle navigation interface comprising a map; and
display, via the display, a virtual vehicle on a target road on the map, the virtual vehicle corresponding to the physical vehicle;
determine, when the physical vehicle travels to a current position and is in a target traveling scenario, road range data corresponding to the target traveling scenario and the current position; and
update a map span and a view angle for displaying the map to a target map span and a target view angle, the target map span and the target view angle being adapted to the road range data.

17. The vehicle navigation apparatus according to claim 16, wherein in order to determine, when the physical vehicle travels to a current position and is in a target traveling scenario, road range data corresponding to the target traveling scenario and the current position, the processor, upon execution of the plurality of computer-readable instructions, is configured to:
determine road horizontal range data and road vertical range data of the target traveling scenario and the current position when the physical vehicle travels to the current position and is in the target traveling scenario.

18. The vehicle navigation apparatus according to claim 16, wherein the target road comprises a plurality of lanes, and wherein the processor, upon execution of the plurality of computer-readable instructions, is further configured to:
display, via the display, the virtual vehicle in a first lane among the plurality of lanes;
update, when the physical vehicle is in a straight-forward traveling scenario at the current position to which the physical vehicle travels, the map span and the view angle for displaying the map to a set map span and a set view angle in the straight-forward traveling scenario; and
display, in the center of a map updated in the straight-forward traveling scenario, the first lane in which the virtual vehicle is displayed.

19. A non-transitory computer-readable storage medium, having a plurality of computer-readable instructions stored thereon, the plurality of computer-readable instructions, when executed by a processor, cause the processor to:
display, via a display, a vehicle navigation interface for navigating a physical vehicle, the vehicle navigation interface comprising a map; and
display, via the display, a virtual vehicle on a target road on the map, the virtual vehicle corresponding to the physical vehicle;
determine, when the physical vehicle travels to a current position and is in a target traveling scenario, road range data corresponding to the target traveling scenario and the current position; and
update a map span and a view angle for displaying the map to a target map span and a target view angle, the target map span and the target view angle being adapted to the road range data.

20. The non-transitory computer-readable storage medium according to claim 19, wherein in order for the processor to determine, when the physical vehicle travels to a current position and is in a target traveling scenario, road range data corresponding to the target traveling scenario and the current position, the plurality of computer-readable instructions, when executed by the processor, cause the processor to:
calculate, based on road data at the current position, when the physical vehicle travels to the current position and is in a lane change scenario, a road horizontal distance required for the lane change scenario, and calculate, based on the road data at the current position, a maximum vertical extension lane change distance required for lane change from the current position; and
in order for the processor to update a map span and a view angle for displaying the map to a target map span and a target view angle, the target map span and the target view angle being adapted to the road range data, the plurality of computer-readable instructions, when executed by the processor, cause the processor to:
determine, based on the road horizontal distance, the target map span required for updating the map, and determine, based on the required target map span and the maximum vertical extension lane change distance, a target skew angle required for updating the map; and
update the map span and the view angle for displaying the map to the target map span and the target skew angle.
